(19) United States
(12) Patent Application Publication
(10) Pub. No.: US 2025/0311036 A1
(43) Pub. Date: Oct. 2, 2025

(54) APPARATUS AND METHOD FOR DUALSTEER COMMUNICATION IN WIRELESS COMMUNICATION SYSTEM

(71) Applicant: ELECTRONICS AND TELECOMMUNICATIONS RESEARCH INSTITUTE, Daejeon (KR)

(72) Inventors: Jeoung Lak HA, Daejeon (KR); Changki KIM, Daejeon (KR); Tae Yeon KIM, Daejeon (KR)

(73) Assignee: ELECTRONICS AND TELECOMMUNICATIONS RESEARCH INSTITUTE, Daejeon (KR)

(21) Appl. No.: 19/092,899

(22) Filed: Mar. 27, 2025

(30) Foreign Application Priority Data
Apr. 2, 2024 (KR) 10-2024-0044717
Apr. 5, 2024 (KR) 10-2024-0046907
May 24, 2024 (KR) 10-2024-0067690
Aug. 7, 2024 (KR) 10-2024-0105570
Aug. 14, 2024 (KR) 10-2024-0108950
Feb. 27, 2025 (KR) 10-2025-0025871

(51) Int. Cl. H04W 76/15; H04W 68/00

(52) U.S. Cl. CPC H04W 76/15; H04W 68/00

(57) ABSTRACT

Proposed are an apparatus and a method for dualsteer communication in a wireless communication system. An operation method for establishing a session for dualsteer communication in a wireless communication system includes receiving, from a dualsteer device (DSD), a session establishment request message including support for dualsteer, assigning a session management function (SMF) capable of supporting dualsteer, verifying whether dualsteer is subscribed, assigning a user plane function (UPF) capable of supporting dualsteer, and transmitting a session establishment response message including acceptance of dualsteer to the DSD.

### CROSS REFERENCE TO RELATED APPLICATION

The present application claims priority to Korean Patent Application No. 10-2024-0044717, filed Apr. 2, 2024, Korean Patent Application No. 10-2024-0046907, filed Apr. 5, 2024, Korean Patent Application No. 10-2024-0067690, filed May 24, 2024, Korean Patent Application No. 10-2024-0105570, filed Aug. 7, 2024, Korean Patent Application No. 10-2024-0108950, filed Aug. 14, 2024, and Korean Patent Application No. 10-2025-0025871, Feb. 27, 2025, the entire contents of which are incorporated herein for all purposes by this reference.

### BACKGROUND OF THE INVENTION

### Field of the Invention

The present disclosure generally relates to a wireless More particularly, the present communication system. disclosure relates to an apparatus and a method for dualsteer communication in a wireless communication system.

### Description of the Related Art

In a wireless communication system, access traffic steering, switching, and splitting (ATSSS) supports traffic steering, switching, and splitting for access through 3GPP and access through non-3GPP, and provides a service for one user ID.

The multi-access steering, switching, and splitting (MASSS) service supports steering, switching, and splitting for access over two or more access networks within one communication network or access over two or more access networks belonging to different communication network, and supports a service for two or more user IDs.

Two or more accesses to one or more 3GPP communication networks require two or more user IDs or used terminal IDs corresponding thereto. Herein, the case of MASSS with two access networks is called dualsteer. However, the related art lacks a session management method for steering, switching, and splitting for two or more accesses to two or more 3GPP access networks for dualsteer.

In addition, the related art only allows paging with respect to only one UE, so there is no way to handle cases in which a UE is unable to perform access or paging response.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a session management apparatus and method for dualsteer in a wireless communication system.

In addition, the present disclosure is directed to providing an apparatus and a method for dualsteer-based paging processing in a wireless communication system.

In addition, the present disclosure is directed to providing an apparatus and a method for efficient traffic steering and switching between different communication networks or access networks in a wireless communication system.

In addition, the present disclosure is directed to providing an apparatus and a method for dualsteer session establishment and management using a plurality of user identifiers (Subscription Permanent Identifiers, SUPIs) in a wireless communication system.

In addition, the present disclosure is directed to providing an apparatus and a method for a convergence function of a dualsteer device (DSD) in a wireless communication system.

In addition, the present disclosure is directed to providing an apparatus and a method for dualsteer operation of an active-standby type in a wireless communication system.

In addition, the present disclosure is directed to providing an apparatus and a method for traffic forwarding during switching of a dualsteer session in a wireless communication system.

In addition, the present disclosure is directed to providing an apparatus and a method for measuring and managing the performance of a dualsteer session in a wireless communication system.

In addition, the present disclosure is directed to providing an apparatus and a method for registration of a dualsteer device and management of a session identifier in a wireless communication system.

In addition, the present disclosure is directed to providing an apparatus and a method for ensuring continuity of a dualsteer service in a wireless communication system.

According to various embodiments of the present disclosure, there is provided an operation method for establishing a session for dualsteer communication in a wireless communication system, the operation method including: receiving, from a dualsteer device (DSD), a session establishment request message including support for dualsteer; assigning a session management function (SMF) capable of supporting dualsteer; verifying whether dualsteer is subscribed; assigning a user plane function (UPF) capable of supporting dualsteer; and transmitting a session establishment response message including acceptance of dualsteer to the DSD.

According to various embodiments of the present disclosure, there is provided an operation method for session switching for dualsteer communication in a wireless communication system, the operation method including: receiving, from a dualsteer device (DSD), a session request message including a request type indicating dualsteer switching; assigning a dualsteer session to which switching is performed a session management function (SMF) the same as the SMF in charge of a dualsteer session to be switched; verifying whether dualsteer is subscribed; assigning a user plane function (UPF) the same as the UPF in charge of the dualsteer session to be switched; and transmitting a session response message including acceptance of dualsteer to the DSD.

According to various embodiments of the present disclosure, there is provided a paging method for dualsteer communication in a wireless communication system, the operation method including: obtaining, when paging to a first subscription permanent identifier (SUPI) is impossible, access and mobility management function (AMF) information of a second SUPI that is an associated SUPI of the first SUPI from a unified data management (UDM), wherein a request for paging to the second SUPI includes an indication that paging is originally to the first SUPI.

According to various embodiments of the present disclosure, there is provided a session establishment apparatus for dualsteer communication in a wireless communication system, the apparatus including: a transceiver; and a controller operably connected to the transceiver, wherein the controller is configured to receive a session establishment request message including support for dualsteer from a dualsteer Device (DSD), verify whether dualsteer is subscribed, assign a user plane function (UPF) capable of supporting dualsteer, and transmit a session establishment response message including acceptance of dualsteer.

The apparatus and the method according to various embodiments of the present disclosure provide an efficient session management scheme for dualsteer device, thereby efficiently performing traffic steering and switching between different communication networks or access networks.

In addition, the apparatus and the method according to various embodiments of the present disclosure provide a paging processing method using a plurality of user identifiers, thereby improving continuity and reliability of a communication service.

In addition, the apparatus and the method according to various embodiments of the present disclosure provide a dualsteer operation method of an active-standby type, thereby using network resources efficiently.

In addition, the apparatus and the method according to various embodiments of the present disclosure provide a method for measuring and managing performance of a dualsteer session, thereby selecting an optimal network path and improving service quality.

In addition, the apparatus and the method according to various embodiments of the present disclosure can manage a plurality of accesses in an integrated manner through a convergence function of a dualsteer device, thereby performing traffic control and session management efficiently.

In addition, the apparatus and the method according to various embodiments of the present disclosure provide a method of forwarding traffic efficiently during session switching, thereby minimizing service disruption and improving user experience.

Effects that may be obtained from the present disclosure will not be limited to only the above described effects. In addition, other effects which are not described herein will become apparent to those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows examples of DSD configurations, according to an embodiment of the present disclosure;

FIG. 2 shows examples of DSD configurations, according to an embodiment of the present disclosure;

FIG. 3 shows a configuration in which a dualsteer device (DSD) accesses two radio access networks (RANs) within a home public land mobile network (HPLMN), according to an embodiment of the present disclosure;

FIG. 4 shows a configuration in which a dualsteer device (DSD) accesses two radio access networks (RANs), each belonging to a home public land mobile network (HPLMN) and a visited public land mobile network (VPLMN), respectively, according to an embodiment of the present disclosure;

FIG. 5 shows a configuration in which a dualsteer device (DSD) accesses two different visited public land mobile networks (VPLMNs), according to an embodiment of the present disclosure;

FIG. 6 shows a structure for assigning dualsteer session IDs to sessions within a dualsteer device (DSD), according to an embodiment of the present disclosure;

FIG. 7 shows a switching process of dualsteer traffic, according to an embodiment of the present disclosure;

FIG. 8 shows a dualsteer session establishment procedure for a UE, according to an embodiment of the present disclosure;

FIGS. 9A and 9B show a switching procedure of dualsteer traffic, according to an embodiment of the present disclosure;

FIG. 10 shows a switching procedure of dualsteer traffic, according to an embodiment of the present disclosure;

FIG. 11 shows a session establishment procedure for dualsteer traffic switching, according to an embodiment of the present disclosure;

FIG. 12 shows a method of indirect forwarding to UPF0 during dualsteer switching, according to an embodiment of the present disclosure;

FIG. 13 shows a method of direct forwarding to UPF0 during dualsteer switching, according to an embodiment of the present disclosure;

FIGS. 14 and 15 show a dualsteer traffic switching procedure, according to an embodiment of the present disclosure;

FIG. 16 shows a dualsteer environment, according to an embodiment of the present disclosure;

FIG. 17 shows a steering operation method for determining whether to bind a new application to an existing PDU session in a DSD or to a new PDU session, according to an embodiment of the present disclosure;

FIG. 18 shows an operation method for binding a newly started application App2 to a PDU session while App2 is set as the priority of RAN2 and RAN1 using dualsteer, according to an embodiment of the present disclosure;

FIG. 19 shows an operation method for determining switching when a DSD moves from area A1 to area A2, according to an embodiment of the present disclosure;

FIG. 20 shows a procedure for registering SUPI1 of a DSD in RAN1 and establishing a session, according to an embodiment of the present disclosure;

FIG. 21 shows a procedure for registering SUPI2 of a DSD in RAN2 and establishing a session, according to an embodiment of the present disclosure;

FIG. 22 shows a procedure for SUPI2 of a DSD to perform switching from traffic to DSssn1 to traffic to DSssn2, according to an embodiment of the present disclosure;

FIG. 23 shows a service request procedure, according to various embodiments of the present disclosure;

FIG. 24 shows a paging procedure using dualsteer, according to an embodiment of the present disclosure;

FIG. 25 shows a configuration diagram of a user equipment in a wireless communication system according to various embodiments of the present disclosure;

FIG. 26 shows the configuration of a network entity in a wireless communication system according to various embodiments of the present disclosure; and

FIG. 27 is a diagram illustrating a device configuration according to an embodiment.

### DETAILED DESCRIPTION OF THE INVENTION

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

Hereinafter, the present disclosure relates to an apparatus and a method for dualsteer communication in a wireless communication system. Specifically, the present disclosure describes the following technologies in a wireless communication system:
(1) A technology for managing a session in accessing over two or more access networks within one communication network or accessing over two or more access networks belonging to different communication networks
(2) A technology for setting and managing a session of a dualsteer device (DSD) by using a plurality of user identifiers (SUPIs)
(3) A technology for performing traffic steering, switching, and splitting between different access networks
(4) A technology for performing paging processing in a dualsteer environment
(5) A technology for dualsteer operation of an active-standby type

The terms referring to signals, the terms referring to channels, the terms referring to control information, the terms referring to network entities, the terms referring to elements of an apparatus, and the like used in the description below are only examples for the convenience of description. Accordingly, the present disclosure is not limited to the terms described below, and the terms may be replaced by other terms having the same technical meanings.

In addition, various embodiments of the present disclosure are described using terms used in some communication standards (e.g., the 3rd Generation Partnership Project (3GPP)), but the embodiments are only examples for the description. The various embodiments of the present disclosure may be easily modified and applied to other communication systems.

### Dualsteer Device

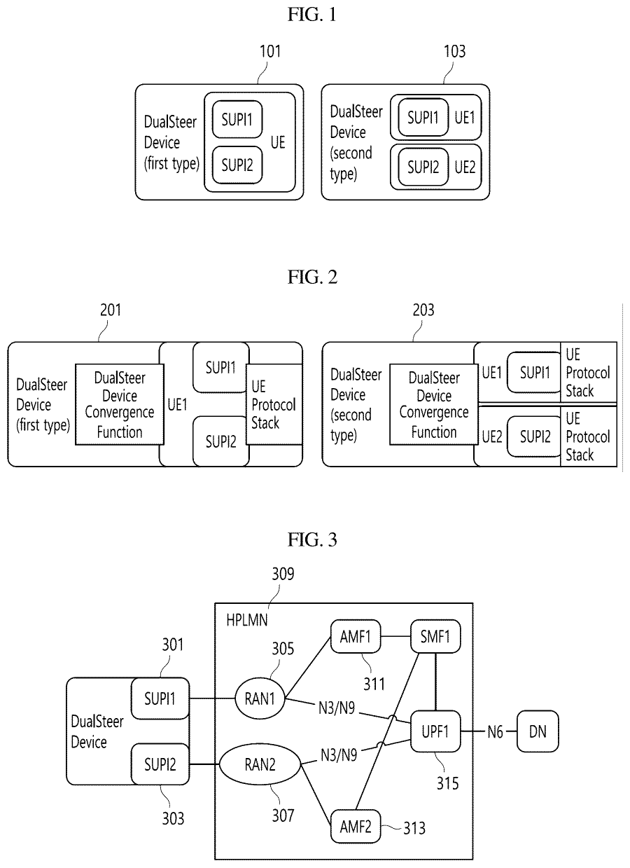

FIG. 1 shows examples of DSD configurations, according to an embodiment of the present disclosure.

Referring to FIG. 1, a dualsteer device (hereinafter, referred to as a “DSD”) is a device that supports access over two or more access networks within one communication network or access over two or more access networks belonging to different communication networks, and may be implemented in two forms, roughly.

The first is a first type DSD 101 in which one UE has two or more SUPIs, and the second is a second type DSD 103 in which two or more UEs each have one SUPI.

In an embodiment, the first type DSD 101 has the form in which SUPI1 and SUPI2 are implemented within a single UE, and is able to access only any one access network at a point in time. This is implemented as a single physical device and is capable of sharing hardware resources efficiently, and a dualsteer convergence function (hereinafter, a “DCF”) is implemented within a single UE.

In an embodiment, the second type DSD 103 has the form in which UE1 has SUPI1 and the UE2 has SUPI2, such that the two UEs each access one access network and are capable of transmitting data simultaneously to the two access networks. This is implemented as two physically separated UEs, and the DCF is charge of the coordination between the two UEs.

In the two types of DSDs 101 and 103, SUPI1 and SUPI2 have a relationship of mutually associated SUPIs. That is, the associated SUPI of SUPI1 is SUPI2, and the associated SUPI of SUPI2 is SUPI1. In this structure, the DCF of the DSD performs a key role in monitoring the registration state and traffic of SUPI1 and SUPI2 according to a dualsteer policy, and managing routing to a particular session.

The DSD according to an embodiment of the present disclosure is not limited to either the first type 101 or the second type 103, and may select suitable form depending on an implementation method. Such flexible structure ensures efficient traffic management and stable service continuity in various network environments.

In particular, the DCF of the DSD performs a function of being in charge of coordinating the order, procedures, and policy for one or more SUPIs to access different access networks. According to an embodiment, the DCF may manage routing to a particular session with respect to the registration state and traffic of SUPI1 and SUPI2, thus enabling efficient use of network resources.

FIG. 2 shows examples of DSD configurations, according to an embodiment of the present disclosure. Specifically, FIG. 2 shows the detailed structures of a first type dualsteer device (DSD) 201 and a second type dualsteer device (DSD) 203. DSDS are divided into two forms depending on how a subscription permanent identifier (SUPI) is implemented.

The first type DSD 201 has the form in which a dualsteer device convergence function (DCF) and two SUPIs (SUPI1 and SUPI2) are implemented within a single UE. The two SUPIs share one protocol stack, and the DCF manages communication and control between the SUPIs. In this structure, all functions are integrated within one physical device, so hardware resources can be efficiently shared.

The second type DSD 203 consists of two independent UEs (UE1 and UE2), and each of the UEs has one SUPI (UE1 has SUPI1 and UE2 has SUPI2) and an independent protocol stack. In this structure, the DCF performs a role in coordinating communication and control between two physically separate UEs. The structure of the second type enables two UEs to access different access networks simultaneously and transmit data.

In both of the two structures 201 and 203, the DCF manages the registration states of the SUPIs, controls traffic steering, switching, and splitting, and is in charge of session management and routing for each SUPI. This enables efficient use of network resources and stable service provision.

### DSD and Network

FIG. 3 shows a configuration in which a dualsteer device (DSD) accesses two radio access networks (RANs) within a home public land mobile network (HPLMN), according to an embodiment of the present disclosure.

Referring to FIG. 3, a first SUPI (SUPI1) 301 of the DSD accesses RAN1 305, and a second SUPI (SUPI2) 303 of the DSD accesses RAN2 307. RAN1 305 and RAN2 307 belong to the same HPLMN 309, and are connected to the network through AMF1 311 and AMF2 313, respectively. AMF1 311 and AMF2 313 may be the same AMF. UPF1 315 is positioned in the core network and serves as an anchor user plane function (UPF) for dualsteer traffic of the first SUPI 301 and the second SUPI 303 through RAN1 305 and RAN2 307.

UPF1 315, which is the anchor UPF, is connected to a data network (DN), and is in charge of a key role in executing traffic switching between two accesses when switching of dualsteer traffic is required. Intermediate UPFs (I-UPFs) may be further configured between UPF1 315 and RAN1 305 and between UPF1 315 and RAN2 307, respectively, and the intermediate UPFs (I-UPFs) may be different from each other or the same. This structure enables efficient management of multiple accesses within the same HPLMN 309, and stable performance of traffic steering, switching, and splitting.

This network configuration enables the DSD to use a plurality of access networks to provide a service in a single PLMN environment, and enables efficient use of network resources and improvement in service quality.

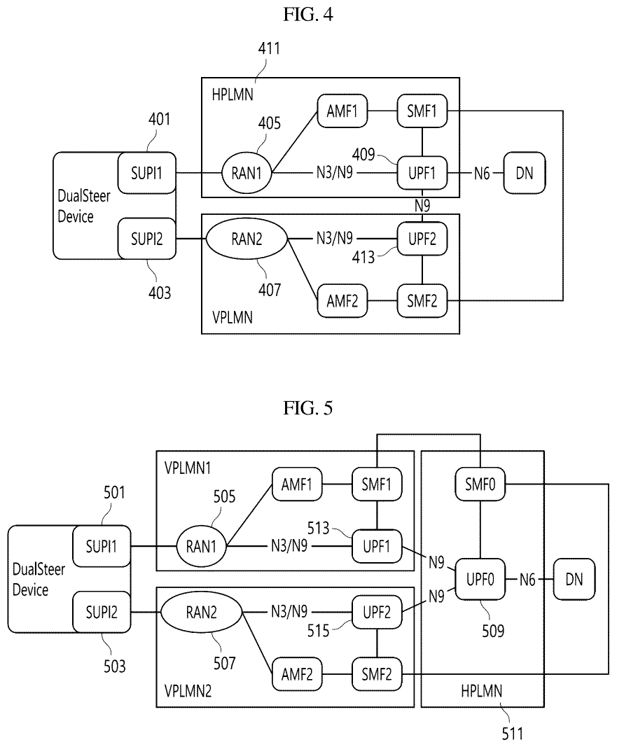

FIG. 4 shows a configuration in which a dualsteer device (DSD) accesses two radio access networks (RANs) belonging to a home public land mobile network (HPLMN) and a visited public land mobile network (VPLMN), according to an embodiment of the present disclosure.

Referring to FIG. 4, a first SUPI (SUPI1) 401 of the DSD accesses RAN1 405, which is a RAN of an HPLMN, and a second SUPI (SUPI2) 403 of the DSD accesses RAN2 407, which is a RAN of a VPLMN. This is a structure that provides a dualsteer service over RANs spanning different PLMNs.

In the core network, UPF1 409 serves as an anchor user plane function (UPF) for dualsteer traffic of the first SUPI 401 and the second SUPI 403, and belongs to an HPLMN 411. UPF2 413 for SUPI2 403 functions as an intermediate UPF (I-UPF), and an additional I-UPF may be configured between UPF1 409 and RAN1 405. In addition, an additional I-UPF may be positioned between UPF2 413 and RAN2 407.

This configuration enables a dualsteer service to be provided in a roaming environment, and enables efficient management of traffic steering and switching between the HPLMN and the VPLMN. In particular, since the anchor UPF is positioned in the HPLMN, centralized traffic control in a home network is achieved, thus enabling stable service quality.

This network configuration enables the DSD to use its home network and a visited network simultaneously, which contributes to improved continuity and reliability of a service.

FIG. 5 shows a configuration in which a dualsteer device (DSD) accesses two different visited public land mobile networks (VPLMNs), according to an embodiment of the present disclosure.

Referring to FIG. 5, a first SUPI 501 of the DSD accesses RAN1 505, which is a RAN of VPLMN1, and a second SUPI 503 of the DSD accesses RAN2 507, which is a RAN of VPLMN2. UPF0 509 serves as an anchor user plane function (UPF) for dualsteer traffic of the first SUPI 501 and the second SUPI 503, and is positioned in an HPLMN 511. UPF1 513 for SUPI 1 501 and UPF2 515 for SUPI 2 503 function as intermediate UPFs (I-UPFs).

In this configuration, an additional I-UPF may be positioned between UPF1 513 and RAN1 505, and an additional I-UPF may be positioned between UPF2 515 and RAN2 507. An SMF for controlling the anchor UPF is named an anchor SMF for convenience, and is positioned in the HPLMN and is in charge of overall dualsteer session management.

A feature of this network configuration is that the DSD is able to use two different visited networks simultaneously. This enables the user to use the characteristics and good points of each visited network, and enables more flexible service provision. In particular, since the anchor UPF and the anchor SMF are positioned in the HPLMN, consistent control and management of a service over two different VPLMNs are achieved.

This structure simultaneously uses two or more networks in one region, thereby ensuring continuity and stability of a service. In addition, an optimal path may be selected depending on the network state or performance of each VPLMN, thereby improving service quality.

The embodiments described below may be applied to each of the configurations in FIGS. 3, 4, and 5 even if it is described that the PLMNs of SUPI1 and SUPI2 are different from each other or the PLMNs of SUPI1 and SUPI2 are the same.

### Dualsteer Session ID

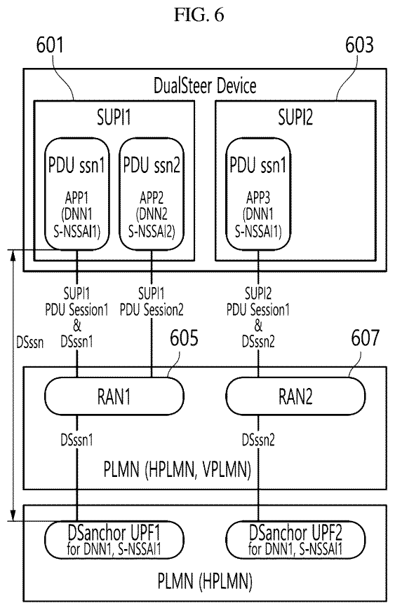

FIG. 6 shows a structure for assigning dualsteer session IDs to sessions established within a dualsteer device (DSD), according to an embodiment of the present disclosure. Specifically, FIG. 6 shows a session identification scheme and a structure of a dualsteer device (DSD). The present disclosure proposes a new session identification and management method that is differentiated from the related art.

In a system in the related art, an individual UE has only one SUPI, so only a PDU session ID is sufficient for identification of a session on the UE side. On the network side, individual sessions are distinguished from each other with a combination of a SUPI and a PDU session ID, the (SUPI, PDU session ID) form. However, since the DSD supports one or more SUPIs, a new identification scheme is required for this. Therefore, in the present disclosure, the scheme is defined as a new identifier called dualsteer session ID (DSssnId).

Referring to FIG. 6, RAN1 605 is accessed by SUPI1 601 and RAN2 607 is accessed by SUPI2 603, wherein RAN1 605 and RAN2 607 may belong to the same PLMN or different PLMNs. Two sessions, PDU Session 1 and PDU Session 2, are established by SUPI1 601, and among these, PDU Session 1 is established as a dualsteer session. PDU Session 1 is established as a dualsteer session by SUPI2 603. In this case, to distinguish PDU Session 1 of SUPI1 and PDU Session 1 of SUPI2 from each other, these are identified as DSssn1 and DSssn2, respectively. The PDU session IDs of SUPI1 and SUPI2 may be different from each other or the same according to an embodiment.

In the present disclosure, DSanchor UPF1 and DSanchor UPF2 may be the same UPF.

In the present disclosure, a pair of sessions, DSssn1 and DSssn2, for dualsteer/switching may be referenced in the following three methods.

A first method is to use abbreviated session identifiers, such as DSssn1 and DSssn2. In this case, the corresponding DSssnId is assigned by the anchor SMF.

A second method is to use both the SUPI and the PDU session ID, such as (SUPI1, PDUssn1) and (SUPI2, PDUssn1).

A third method is to use only different SUPIs for the same PDU session ID, such as (SUPI1) and (SUPI2) for PDUssn1, for reference. The same PDU session ID (PDUssn1) is used for bott SUPI1 and SUPI2.

In the second and the third method, the PDU session ID assigned by the UE may be used as it is, and the identifier for which the network the SUPI accesses may be used instead of the SUPI. For example, DSregId1 and DSregId2 representing access information, which is created in a registration procedure of each SUPI, for the accessed network may be used instead of SUPI1 and SUPI2, respectively, to distinguish between DSssn1 and DSssn2.

That is, when SUPI1 and SUPI2 use the same PDU session ID for one dualsteer session, (Ssn1, DSreg1) and (Ssn1, DSreg2) may be used instead of (Ssn1, SUPI1) and (Ssn1, SUPI2). Furthermore, representation only with DSreg1 and DSreg2 may be made using Ssn1 implicitly.

In addition, when SUPI1 and SUPI2 use different PDU session IDs, (Ssn1, DSreg1) and (Ssn2, DSreg2) may be used instead of (Ssn1, SUPI1) and (Ssn2, SUPI2), and identification only with DSreg1 and DSreg2 may be made using Ssn1 or Ssn2 implicitly.

In addition, DSssn1 and DSssn2 may be distinguished from each other using DScorrel representing dualsteer session correlation information, which is created in a dualsteer registration or session establishment procedure of two SUPIs, for two accessed networks. For example, when SUPI1 and SUPI2 use different PDU session IDs, (Ssn1, DScorrel) and (Ssn2, DScorrel) may be used instead of (Ssn1, SUPI1) and (Ssn2, SUPI2), and a session may be identified only with Ssn1 or Ssn2 by using DScorrel implicitly.

### Switching of Dualsteer Session

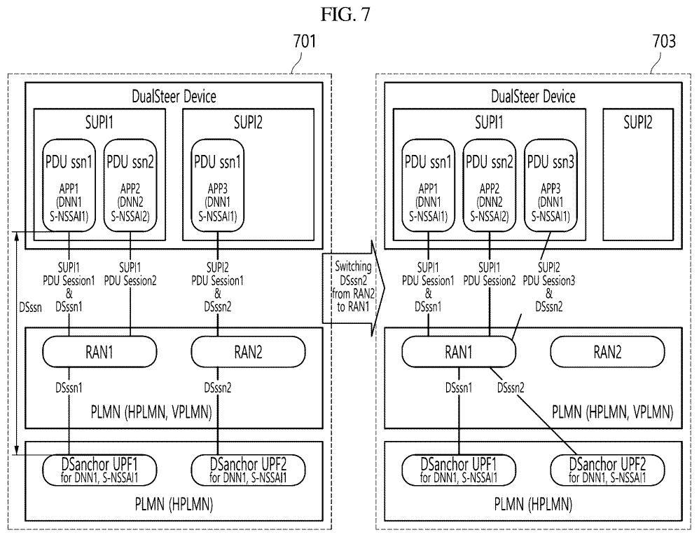

FIG. 7 shows a switching process of dualsteer traffic, according to an embodiment of the present disclosure. Specifically, FIG. 7 shows changes in the configuration of a dualsteer device (DSD) and a session state before and after switching.

Box 701 shows an initial state, wherein SUPI1 establishes DSssn1 to PLMN1 over RAN1 and maintains the session. SUPI1 has two sessions, PDU Session 1 and PDU Session 2, to execute APP1 and APP2, respectively. Simultaneously, SUPI2 establishes DSssn2 over RAN2 and executes APP3. Each application is serviced through a designated DNN and S-NSSAI.

Box 703 shows the state after DSssn2 is subjected to dualsteer traffic switching to RAN1 through SUPI1 when the QOS of DSssn2 drops or is expected to drop. In this process, PDU Session 3 is created with SUPI1 over RAN1, and DSssn2 used with SUPI2 over RAN2 is switched to a newly created PDU Session 3.

In the present disclosure, DSanchor UPF1 and DSanchor UPF2 may be the same UPF.

The switching process has the following characteristics:
(1) Ensured traffic continuity: the continuity of a service is maintained during switching of DSssn2.
(2) Session management: creation, modification, and release of a PDU session are systematically managed during the switching process, and service quality of each application is ensured.
(3) Interworking between PLMNs: it is designed to enable seamless switching between different PLMNs.

This switching method enables the DSD to dynamically deal with network state changes, and may provide the optimal service quality to the user. In particular, continuity of traffic can be ensured and efficient use of network resources can be achieved.

### Dualsteer Session Establishment Procedure of UE

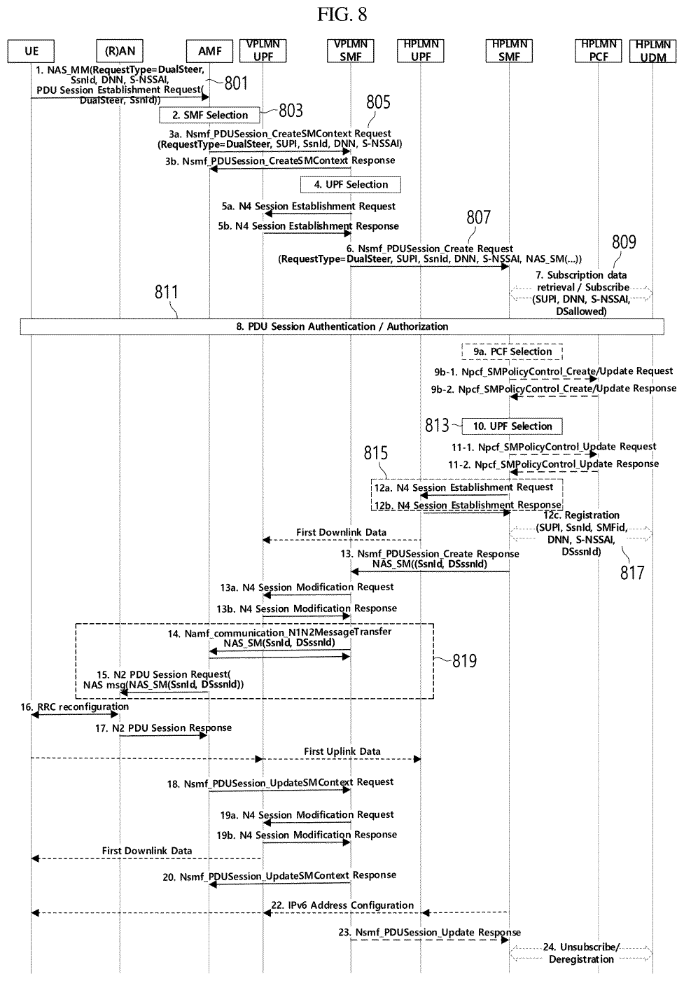

FIG. 8 shows a dualsteer session establishment procedure of a UE, according to an embodiment of the present disclosure. Specifically, FIG. 8 shows a procedure obtained by modifying the UE-requested PDU session establishment procedure for home routing scenarios in 4.3.2.2.2 of 3GPP TS 23.502, to be capable of supporting dualsteer. This procedure is performed after the corresponding SUPI of the DSD is already registered in the PLMN, and a description thereof is based on the case in which the VPLMN and the HPLMN are distinguished from each other. However, this procedure may be simplified when the VPLMN and the HPLMN are the same. For example, when the UE is in the access network of the HPLMN, there may be no separate V-SMF and the H-SMF may serve as the SMF or V-SMF.

In step 801 (Step 1), the UE may transmit a session establishment message for the SUPI of the DSD. Specifically, PDU Session Establishment Request may be created as an NAS SM message and may be included in an NAS MM message (for example, UL NAS Transport). Herein, the NAS MM message, UL NAS Transport, or the NAS SM message, PDU Session Establishment Request, or both may specify dualsteer as a session request type (RequestType) parameter. In an embodiment, dualsteer, or dualsteer potential switching, or dualsteer switching may be used. In step 801 (Step 1), functionality of the UE to be used for dualsteer may be included such as an IP-based multipath protocol, for example MPTCP or MPQUIC. MPQUIC may be further subdivided into MPQUIC-IP, MPQUIC-UDP, and MPQUIC-Ethernet depending on the type of supported protocol.

In step 803 (Step 2), the AMF may select the SMF capable of dualsteer depending on the value of RequestType. The UE may indicate a PDU session ID as well as a dualsteer session in the PDU session establishment request message. Specifically, dualsteer may be denoted as a bit field in 5GSM capability information. The UE may create the DSssnId or DScorrel. In addition, the DSssnId, DScorrel, or DSregId may be included in 5GSM capability information.

In step 803 (Step 2), the AMF may recognize RequestType in the NAS MM message received in step 801 (Step 1) to select the SMF capable of supporting dualsteer when dualsteer or dualsteer potential switching is specified. The AMF may select the SMF of the PLMN to which the AMF belongs. That is, the AMF of the VPLMN may select the SMF of the VPLMN, and the AMF of the HPLMN may select the SMF of the HPLMN. In addition, when selecting the SMF for the dualsteer session, the AMF may use home-routed roaming for determination, and may select the SMF of the HPLMN therefor. Herein, the AMF may search for the SMF capable of providing the DNN, the S-NSSAI, and the dualsteer service requested by the UE. To this end, when the AMF searches for the SMF, whether dualsteer is supported may be included as a query parameter in the NRF.

In step 805 (Step 3a) and step 807 (Step 6), when the AMF makes a request to the SMF and the SMF makes a request to another SMF for session establishment, required information may be forwarded. Dualsteer or dualsteer potential switching may be specified in RequestType of Nsmf_PDUSession_CreateSMContext Request message and/or Nsmf_PDUSession_Create Request message. In addition, the DSssnId, DScorrel, or DSregId may be included in RequestType of Nsmf_PDUSession_CreateSMContext Request message and/or Nsmf_PDUSession Create Request message. RequestType may be used when the VPLMN SMF selects the HPLMN SMF in step 807 (Step 6) and when the SMF selects the UPF in step 813 (Step 10). To this end, when searching the NRF for the UPF, whether dualsteer is supported may be included as a query parameter.

In step 807 (Step 6), a home-routed session establishment procedure is performed on the session requesting dualsteer. To this end, the SMF of the VPLMN may search for the SMF of the HPLMN. Herein, the SMF of the VPLMN searches for the SMF of the HPLMN capable of providing the DNN, S-NSSAI, and dualsteer service for which the session is requested. When the NRF of the VPLMN searches the NRF of the HPLMN for the SMF, whether dualsteer is supported may be included as a query parameter. The HPLMN may be identified by the MCC and MNC included in the SUPI, SUCI, or GUTI provided by the UE.

According to an embodiment, the V-SMF may use home-routed roaming for determination, and may search for the H-SMF therefor.

In step 809 (Step 7), the SMF may receive session management (SM) subscriber data from the UDM. When the SMF makes a request to the UDM for subscriber data for the SUPI, the DNN and the S-NSSAI and whether dualsteer is supported may be included. The UDM may provide subscriber data for the requested SUPI. The subscriber data may include whether the corresponding SUPI is capable of dualsteer (DSallowed) in the DNN and S-NSSAI. In addition, when the corresponding SUPI is capable of dualsteer, information on the associated SUPI of the provided SUPI may be included. When the associated SUPI of the SUPI exists, the SM subscriber data provided by the UDM to the SMF may include at least one selected from the group of the DSssnId, DScorrel, and DSregId of the associated SUPI. Even if the query of the SMF does not include dualsteer, the UDM may reply with whether dualsteer is possible.

In step 809 (Step 7), the SMF or UDM may verify whether the corresponding PDU session is able to use dualsteer, and may assign a dualsteer session ID (DSssnId) or dualsteer session correlation information (DScorrel). Herein, in addition to the PDU session ID, DScorrel or DSredId may be used together.

In step 811 (Step 8), DSallowed received in step 809 (Step 7) may be recognized. When DSallowed indicates False and the corresponding SUPI is unable to use dualsteer in the DNN and S-NSSAI, an ordinary PDU session in the related art rather than dualsteer may be established. Alternatively, a PDU session establishment reject message may be forwarded to the UE in step 819 (Steps 13, 14, and 15). When DSallowed indicates True, the SMF may assign the DSssnId to the PDU session of the SUPI being established, and may perform address assignment using assignment of an IP address/prefix or assignment of an interface ID for IPv6 to be used by the UE or both depending on the PDU session type.

In step 813 (Step 10), the SMF may select the UPF that supports the corresponding DNN or S-NSSAI and also supports dualsteer. The selected UPF may be a dualsteer anchor UPF, and UPFid, the identifier of the selected UPF, may be stored together with the DNN and S-NSSAI in the SMF. The IP address information assigned in step 809 (Step 8) and the UPFid may be stored together in step 817 (Step 12c). This stored value may be referenced in step 809 (Step 7). In addition, the N4 session ID set for the PFCP between the SMF and the UPF may use the same value or different values depending on an embodiment. That is, two PFCP sessions for dualsteer may be assigned the same N4 session ID or different N4 session IDs. The N4 session ID may be subdivided into a CP session endpoint identifier (SEID) used on the SMF side and an UP SEID used on the UPF side. With respect to each of the CP SEID and the UP SEID, the same value or different values may be used for two sessions for dualsteer. In an embodiment, with respect to the CP SEID, DSssn1 and DSssn2 may be assigned different values, such as 1 and 2, or the same values, such as 1 and 1, respectively. Separately, with respect to the UP SEID, DSssn1 and DSssn2 may be assigned different values, such as 3 and 4, or the same values, such as 3 and 3, respectively.

In step 815 (Step 12), when functionality to be used for dualsteer is an IP-based multipath protocol, the SMF may instruct the UPF to apply the protocol. The UPF may further assign a link-specific multipath address to the corresponding access. For example, in the case of multipath protocols, such as MPTCP and MPQUIC, each path may be further assigned an IP address/prefix as a link-specific multipath address.

In an embodiment, in the case of dualsteer, DSssn1 and DSssn2 may be further assigned respective link-specific multipath addresses.

In an embodiment, the MPQUIC may be further subdivided into MPQUIC-IP, MPQUIC-UDP, and MPQUIC-Ethernet depending on the type of supported protocol. Herein, as many link-specific multipath addresses may be further assigned as there are paths.

In step 817 (Step 12c), the SMF may register the PDU session ID (SsnId) established for the SUPI together with the ID (SMFid) of the SMF in charge of dualsteer and the DSssnId in the UDM. Herein, the DNN, S-NSSAI, and RATtype of the established PDU session may also be registered together. The UDM may registers the corresponding information in the UDR, and in step 809 (Step 7), the UDM may read the information from the UDR to provide the same to the SMF.

In step 819 (Steps 14 and 15), the SMF may create a dualsteer rule from a PCC rule received from the PCF in procedure 11, and may provide the dualsteer rule to the UE. The PCF may provide the SMF with the PCC rule including policy information to be used by the dualsteer device to apply dualsteer for traffic. More specifically, traffic may be described as service data flow detection information or an application descriptor, and dualsteer functionality that indicates whether dualsteer is applied to the traffic and a processing method may be included in the PCC rule. In addition, priority information for each access may be included in the PCC rule.

The SMF may create a dualsteer rule from the PCC rule. According to an embodiment, the dualsteer rule may be used extending an existing URSP or may be used separately from the URSP. The URSP may specify application and functionality of dualsteer, and priority information for each access may be included.

Finally, the SMF may provide the PDU session identifier set in PDU Session Establishment Accept provided to the UE, together with at least one selected from the group of the DSssnId, acceptance of the dualsteer request, the URSP including the dualsteer rule, and an independent dualsteer rule.

### Switching Procedure (Switching Starting from UE) of Dualsteer Traffic

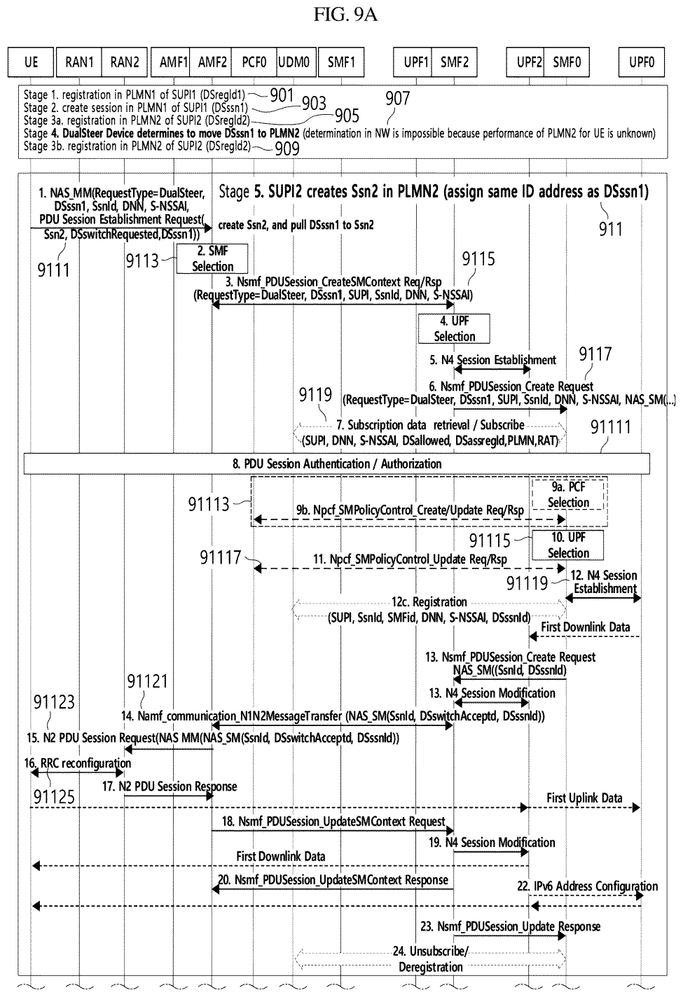

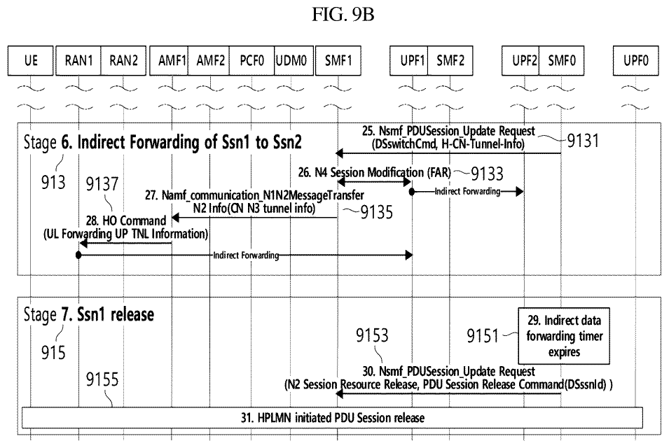

FIGS. 9A and 9B show a switching procedure of dualsteer traffic, according to an embodiment of the present disclosure. Specifically, FIGS. 9A and 9B show a session management procedure for dualsteer traffic switching starting from the UE.

The procedure shown in FIGS. 9A and 9B may be an example of dualsteer traffic switching of DSssn1 to PLMN2 through SUPI2 when the QoS of DSssn1 drops or is expected to drop while SUPI1 has already established and maintained DSssn1 in PLMN1 over RAN1. To this end, DSssn2 may be created with SUPI2 to PLMN2 over RAN2, traffic of DSssn1 being transmitted may be forwarded to DSssn2, and finally, DSssn2 may be used and DSssn1 may be released.

When SUPI1 creates DSssn1 through RAN1, AMF1, SMF1, and UPF1 of PLMN1, SMF0 and UPF0 may be connected as the anchor SMF and the anchor UPF, respectively. When SUPI2 creates DSssn2 through RAN2, AMF2, SMF2, and UPF2 of PLMN2, SMF0 and UPF0, which are the anchor SMF and the anchor UPF, may be applied. PLMN1 may be interchangeable with VPLMN1, PLMN2 may be interchangeable with VPLMN2, and HPLMN may be interchangeable with PLMNO. SMF1 and SMF2 may correspond to the I-SMF and UPF1 and UPF2 may correspond to the I-UPF.

In Stage 1 901 of FIG. 9A, SUPI1 of the DSD may be registered in PLMN1 through the registration procedure. Herein, information on the registered access network may be named DSregId1. DSregId1 may indicate (SUPI1, PLMN1/RAN1) and may pass through RAN1/AMF1.

In Stage 2 903 of FIG. 9A, SUPI1 of the DSD may establish a PDU session capable of dualsteer in PLMN1. As in the procedure in FIG. 8, DSssn1 may be assigned as a dualsteer session identifier. DSssn1 may indicate (SUPI1, PDU Session1), and may pass through SMF1/UPF1 and may be anchored to SMF0/UPF0. SMF1 and UPF1 may be named I-SMF1 and I-UPF1, respectively.

In Stage 3 905 and 909 of FIG. 9A, SUPI2 of the DSD may be registered in PLMN2 through the registration procedure. Herein, information on the registered access network may be named DSregId2. DSregId2 may indicate (SUPI2, PLMN2/RAN2) and may pass through RAN2/AMF2. Stage 3 may be executed before or after Stage 4 depending on an embodiment. Stage 3 executed before Stage 4 may correspond to Stage 3a, and Stage 3 executed after Stage 4 may correspond to Stage 3b.

In Stage 4 907 of FIG. 9A, while traffic of the session of DSssn1 is in progress, the DSD may determine switching of the session to PLMN2. Determination of switching may be due to the mobility characteristics of the DSD, or possible changes in traffic QoS.

In Stage 5 911 of FIG. 9A, the DSD may establish PDU Session1 in PLMN2 (Ssn2 denotes PDU Session1 of SUPI2 in the drawing for ease of identification). This session may be assigned DSssn2. DSssn2 may be assigned the same IP address as DSssn1. The link-specific multipath addresses may assign different addresses to DSssn1 and DSssn2.

Stage 5 911 of FIG. 9A may use FIG. 8, and may further describe steps with differences.

In Step 1 9111 of Stage 5 911, the UE may include DSssnId to be switched in the NAS MM message. The UE may change RequestType to dualsteer or dualsteer switching for use.

The UE may indicate session establishment for dualsteer switching in addition to the PDU session ID in PDU Session Establishment Request or PDU Session Modification Request in the NAS SM message. The UE may include DSssnId to be switched to a newly established session. While establishing PDU Session1 of SUPI2, switching of DSssn1, which is PDU Session1 of SUPI1, to PDU Session of SUPI2 may be requested. Other settings, such as the DNN, S-NSSAI, PDU session type, and SSC mode, may be the same as those used in Stage 2 when establishing a session of DSssn1.

In Step 1 9111 of Stage 5 911, in order to have PDU Session1 of SUPI1 switched to PDU Session 2 of SUPI2, DSssn1 representing PDU Session1 of SUPI1 may be used in the following three methods:
\textcircled{1} First method: use DSssn1, which is a value assigned separately to represent SUPI1 and PDU Session1
\textcircled{2} Second method: use the value of DSssn1 directly as the SUPI and PDU session ID (e.g., SUPI1 and PDU Session1)
\textcircled{3} Third method: use the value of DSssn1 directly as the SUPI only (e.g., SUPI1) (in this case, when the PDU session ID of SUPI1 is PDU Session1, the PDU session ID of SUPI2 use the same value, PDU Session1)

In the case of the second method and the third method, DScorrel or DSredId may be used instead of the SUPI. In Step 2 9113 of Stage 5 911, the AMF may assign the SMF that is the same as the SMF which is in charge of a dualsteer session to be switched. The AMF may provide DSssnId to the UDM in order to obtain information, from the UDM, on the SMF processing DSssn1 that will form dualsteer with the session to be currently established. The SMF may provide DSssnId for dualsteer when requesting the UDM for Nudm_SubscriberDataManagement or Nudm_UEContextManagement service.

In Step 3 9115 of Stage 5 911, the AMF may include the DSssnId to be subjected to dualsteer switching in Nsmf_PDUSession_CreateSMContext Request message requesting the SMF for session establishment. Herein, RequestType may be changed to dualsteer or dualsteer switching and used. When PDU Session Modification Request is used in Step 1 9111 of Stage 5 911, the AMF may use Nsmf_PDUSession_UpdateSMContext Request message requesting the SMF for session modification. This message may include the DSssnId to be subjected to dualsteer switching or RequestType may be changed to dualsteer or dualsteer switching and used.

In Step 6 9117 of Stage 5 911, when the AMF or the SMF of the VPLMN searches for the H-SMF, the SMF of the HPLMN the same as the dualsteer session to be switched may be assign.

In Step 7 9119 of Stage 5 911, Step 7 may be omitted when the SUPI2 is registered as an associated SUPI in the SM subscriber data of SUPI1 received from the UDM in Stage 2 903 and SUPI1 and SUPI2 share the SM subscriber data. DSallowed for SUPI2 may depend on DSallowed for SUPI1, which is the associated SUPI. This may be because the associated SUPI of SUPI1 is SUPI2 and the associated SUPI of SUPI2 is SUPI1.

The SMF or the UDM may verify whether the PDU session is able to use the associated SUPI of the SUPI and dualsteer.

In Step 8 91111 of Stage 5 911, DSssnId of the session assigned SUPI2 may be different from DSssn1. DSssn2 may be assigned the same IP address assigned to DSssn1.

Assignment of IP addresses may be performed by the SMF or the UPF (in Step 10 91115). Assignment of IP addresses may use assignment of an IP address/prefix, or assignment of an interface ID for IPv6 to be used by the UE, or both depending on the PDU session type.

In Step 9 91113 of Stage 5 911 and Step 11 91117 of Stage 5 911, in order to obtain SMpolicy for DSssn2, the SMF may request the PCF for SMpolicy by using the same SMpolicyAssociationID assigned to DSssn1. The dualsteer rule of the PCC rule that the PCF provides to the SMF may be different from the one provided for DSssn1. The SMF may omit the PCF request process to obtain SMpolicy for DSssn2 and may apply the same SMpolicy applied to DSssn1.

In Step 10 91115 of Stage 5 911, the SMF may assign the UPF the same as the UPF assigned to DSssn1. The SMF may use N4sessionId the same as or different from N4sessionId assigned to DSssn1. The UPF may use N4sessionId the same as or different from N4sessionId assigned to DSssn1. N4sessionId may be the CP session endpoint identifier (SEID) and the UP SEID at the SMF and the UPF, respectively.

In Step 12 91119 of Stage 5, the link-specific multipath addresses assigned by the UPF depending on dualsteer functionality may assign different addresses to DSssn1 and DSssn2. The SMF may instruct the UPF to move or copy the downlink PDR, which is applied to DSssn1 by the dualsteer anchor UPF, to DSssn2, and if it is copied, a higher priority may be applied. Traffic forwarded to DSssn1 by applying the packet detection rule (PDR) to downlink traffic may be changed to be forwarded to DSssn2 by deleting the PDR of DSssn1 or by applying a lower priority to the PDR of DSssn1 for routing to DSssn2. Other rules, such as a forwarding action rule (FAR), a usage reporting rule (URR), a QOS enforcement rule (QER), a buffering action rule (BAR), and a signaling rate restriction rule (SRR), applied to DSssn1 may be instructed to be applied in the same manner. One or more “end marker” packets may be transmitted down DSssn1.

In Steps 14 91121 and 15 91123 of Stage 5 911, the SMF may provide the UE with information that dualsteer session switching requested by the UE is accepted. The H-SMF may forward a dualsteer session establishment result to the V-SMF with Nsmf_PDUSession_Create_Response. The SMF may forward Namf_N1N2MessageTransfer_Req to the AMF. The AMF may forward PDU Session Establishment Accept or PDU Session Modification Command to the UE, further including a switching result or a dualsteer session ID or both.

In Step 16 91125 of Stage 5 911, the DSD may use DSssn2 to continue using the service used in DSssn1.

In Stage 6 of FIG. 9B, traffic of DSssn1 being forwarded may continue communicating through DSssn2 via direct forwarding or indirect forwarding. The service used in DSssn1 may continue being used in DSssn2, but traffic that is in progress of forwarding down the anchor UPF may be first forwarded to the UE via direct forwarding or indirect forwarding, and then new traffic of the service is transmitted and received to maintain the order of packets.

Direct forwarding may be applied when there is a direct communication path between RAN1 in charge of DSssn1 and RAN2 in charge of DSssn2. When there is no direct communication path, indirect forwarding may be applied. Indirect forwarding may be described based on forwarding from RAN1 to UPF1, and from UPF1 to UPF2. Similarly, forwarding from RAN1 to UPF1, from UPF1 to UPF0, and from UPF0 to UPF2 may also be applied.

In Step 25 9131 of Stage 6 913, the I-SMF (I-SMF1) may provide a dualsteer switching command (DSswitchcmd) for DSssn1 and DSssn2 tunnel information of the dualsteer anchor UPF for indirect tunnel setting. The tunnel information may be H-CN tunnel info to be received by the anchor UPF from I-UPF1 to DSssn2 with respect to downlink traffic to DSssn1.

In Step 26 9133 of Stage 6 913, I-SMF1 may set DSssn2 tunnel information of the dualsteer anchor UPF received in Step 25 9131 in the FAR for uplink traffic of DSssn1 to I-UPF1 of DSssn1. I-UPF1 may forward uplink traffic of DSssn1 from RAN1 to the tunnel of DSssn2 of the anchor UPF.

In Step 27 9135 of Stage 6 913, I-SMF1 may instruct the AMF (AMF1) through which DSssn1 passes to forward downlink traffic received by the RAN back to UPF1. CN N3 tunnel information of I-UPF may also be provided. Tunnel information may be V-CN tunnel information to be received by I-UPF1 from RAN1 with respect to downlink traffic to DSssn1. Uplink traffic may be traffic that was originally downlink traffic but is obtained by forwarding the downlink traffic uplink from RAN1.

In Step 28 9137 of Stage 6 913, AMF1 may provide the RAN (RAN1) through which DSssn1 passes with the CN N3 tunnel information of the UPF received in Step 27 9135 so that downlink traffic received by the RAN is indirectly forwarded back to UPF1. Downlink traffic that is in progress from UPF0 to UPF1, and from UPF1 to RAN1 with respect to DSssn1 may be indirectly forwarded from RAN1 back to UPF1, and from UPF1 to UPF2. UPF2 may buffer downlink traffic from UPF0 until the “end marker” transmitted in Step 12 is received and may forward the indirectly forwarded packets first to RAN2. UPF2 may forward, to RAN2, the packets buffered after the “end marker” is received, thereby maintaining the packet order.

In Stage 7 915 of FIG. 9B, DSssn1 may be released after a predetermined period of time elapses. The UE or the H-SMF may start release of the switched previous dualsteer session.

In Step 29 9151 of Stage 7 915, downlink traffic that is in progress until UPF0 transmits “end marker” for DSssn1 may be forwarded by Stage 6 913. After sufficient time elapses for traffic in progress until the “end marker” to be completely forwarded, SMF0, which is the anchor SMF servicing DSssn1, may perform Step 30 9153.

In Step 30 9153 of Stage 7 915, the SMF may transmit a command for session release to I-SMF1 managing DSssn1. Herein, NGAP message Transfer for N2 session release and the NAS message for session release of the UE may be included. PDU Session Release Command for session release of the NAS may further include DSssnId (herein, DSssn1) to be released.

Step 31 9155 of Stage 7 915 may follow 4.3.4.3 UE or network requested PDU Session Release for home-routed roaming of TS23.502. However, when the same IP address is assigned to DSssn1 and DSssn2, the assigned IP address information may not be released during release of DSssn1 from which switching is performed until release of DSssn2 to which switching is performed.

### Dualsteer Release Procedure of UE

The release procedure of the dualsteer session may be the same as the session release procedure in the related art, 4.3.4.3 UE or network requested PDU Session Release for home-routed roaming of TS23.502 (not shown). Upon session release, the HPLMN SMF may release the IP address/prefix and interface ID assigned to the session. However, if the same IP address is assigned to one or more dualsteer sessions, the IP address information may be released only when the last one session is released. In case of applying the IP-based multipath protocol, the link-specific multipath address assigned to the access may also be released.

### Switching Procedure (Switching Starting from Network) of Dualsteer Traffic

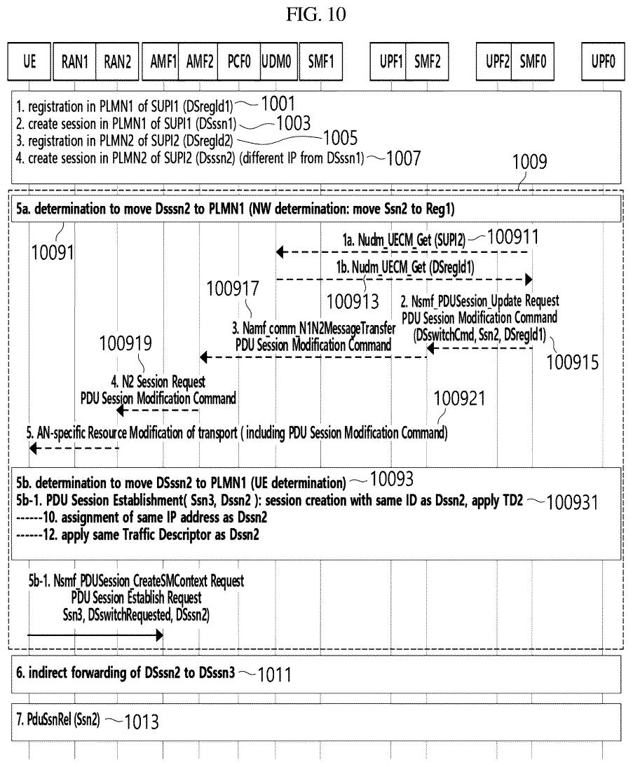

FIG. 10 shows a switching procedure of dualsteer traffic, according to an embodiment of the present disclosure. Specifically, FIG. 10 shows a dualsteer traffic switching procedure starting from the network.

In the initial state, SUPI1 may hold DSssn1 in PLMN1 over RAN1. SUPI2 may hold DSssn2 in PLMN2 over RAN2. DSssn2 may perform dualsteer traffic switching to PLMN1 registered by SUPI1.

The HPLMN may determine and execute dualsteer switching in the network, considering user mobility and possible QoS degradation. SUPI1 creates DSssn3 to PLMN1 over RAN1. Traffic of DSssn2 being transmitted may be switched to DSssn3. Finally, DSssn3 may be used.

In Stage 1 1001, SUPI1 of the DSD may be registered in PLMN1 through the registration procedure. Registration information of SUPI1 may be named DSregId1. DSregId1 denotes (SUPI1, PLMN1). DSregId1 may pass through RAN1/AMF1.

In Stage 2 1003, SUPI1 of the DSD may establish a dualsteer session in PLMN1. The UE, SMF, or UDM may be assigned DSssn1 as DSssnId. DSssn1 may denote (SUPI1, PDU Session1). DSssn1 may pass through SMF1/UPF1 and may be anchored to SMF0/UPF0. SMF1 and UPF1 may be named I-SMF1 and I-UPF1, respectively.

In Stage 3 1005, SUPI2 of the DSD may be registered in PLMN2 through the registration procedure. Registration information of SUPI2 may be named DSregId2. DSregId2 may denote (SUPI2, PLMN2). DSregId2 may pass through RAN2/AMF2.

In Stage 4 1007, SUPI2 of the DSD may establish a dualsteer session in PLMN2. The UE, SMF, or UDM may be assigned DSssn2 as DSssnId. DSssn2 may denote (SUPI2, PDU Session1). DSssn2 may pass through SMF2/UPF2 and may be anchored to SMF0/UPF0. SMF2 and UPF2 may be named I-SMF2 and I-UPF2, respectively. The IP address of DSssn2 and the IP address of DSssn1 may be the same or different from each other.

In Stage 5 1009, when traffic of DSssn2 session is in progress, the DSD or network may determine switching of the session to PLMN1. The DSD or network may determine switching considering mobility characteristics and possible changes in traffic QoS. Depending on what makes determination of switching, division into Stage 5a 10091 and Stage 5b 10093 may be made.

Stage 5a 10091 may be the case in which the SMF of the 5GC determines switching of DSssn2 to PLMN1.

In Step 1 100911 and 100913 of Stage 5a 10091, the anchor SMF may obtain DSregId for the associated SUPI of the SUPI of DSssn2. The anchor SMF may perform a query on the UDM to obtain UECM.

In Step 2 100915 of Stage 5a 10091, the anchor SMF may command SMF2, which is the I-SMF managing DSssn2, to perform dualsteer switching. The SMF may include, in PDU Session Modification, DualSwitching command, information on the session to be switched, and dualsteer switching guide information. When Step 1 100911 and 100913 of Stage 5a 10091 is not performed, the SMF may provide only a switching command without including the switching guide information. The UE may perform switching to the associated SUPI of the SUPI of DSssn2. The dualsteer switching guide information may be information on the PLMN to be moved. The dualsteer switching guide information may be DSssn1. DSregId1 in which DSssn1 is registered and DSssn1 may be used together.

In Step 3 100917 of Stage 5a 10091, the SMF may forward PDU Session Modification and the dualsteer switching guide information to the AMF.

In Step 4 100919 of Stage 5a 10091, the AMF may forward PDU Session Modification and the dualsteer switching guide information to the RAN.

In Step 5 100921 of Stage 5a 10091, the RAN may forward PDU Session Modification and the dualsteer switching guide information to the UE. The DSD may perform Stage 5b depending on DSregId included in the received information. Depending on DSregId, the RAN and the PLMN in which a session is to be established may be determined. As DSregId, (SUPI, RAN/PLMN) may be used or a particular value DSregId referring to (SUPI, RAN/PLMN) may be used. The DSD may obtain DSregId in the registration procedure of each SUPI.

In Stage 5b 10093, the DSD may determine switching of DSssn2 to PLMN1.

Step 1 100931 of Stage 5b 10093 may be the same as Step 1 9111 of Stage 5 911 shown in FIG. 9A. A PDU session to be newly created may be Ssn3, and a dualsteer session to be switched may be DSssn2. The DSD may determine the RAN/PLMN in which a session is to be created when switching is determined or according to the switching guide information received in Step 5 100921 of Stage 5a 10091.

The subsequent procedure is the same as the remaining procedure in Stage 5 911 shown in FIG. 9A, and a PDU session to be created is Ssn3 and a dualsteer session to be switched is DSssn2 and they are different.

In Stage 6 1011, traffic of DSssn2 being transmitted may be forwarded to DSssn3 via indirect forwarding. This procedure is the same as Stage 6 913 shown in FIG. 9B, except that the PDU session to be created is Ssn3 and the dualsteer session to be switched is DSssn2, which is the difference.

In Stage 7 1013, DSssn2 may be released after a predetermined period of time elapses. This procedure is the same as Stage 7 915 shown in FIG. 9B, except that the PDU session to be created is Ssn3 and the dualsteer session to be switched is DSssn2, which is the difference.

### Session Establishment for Dualsteer Potential Switching

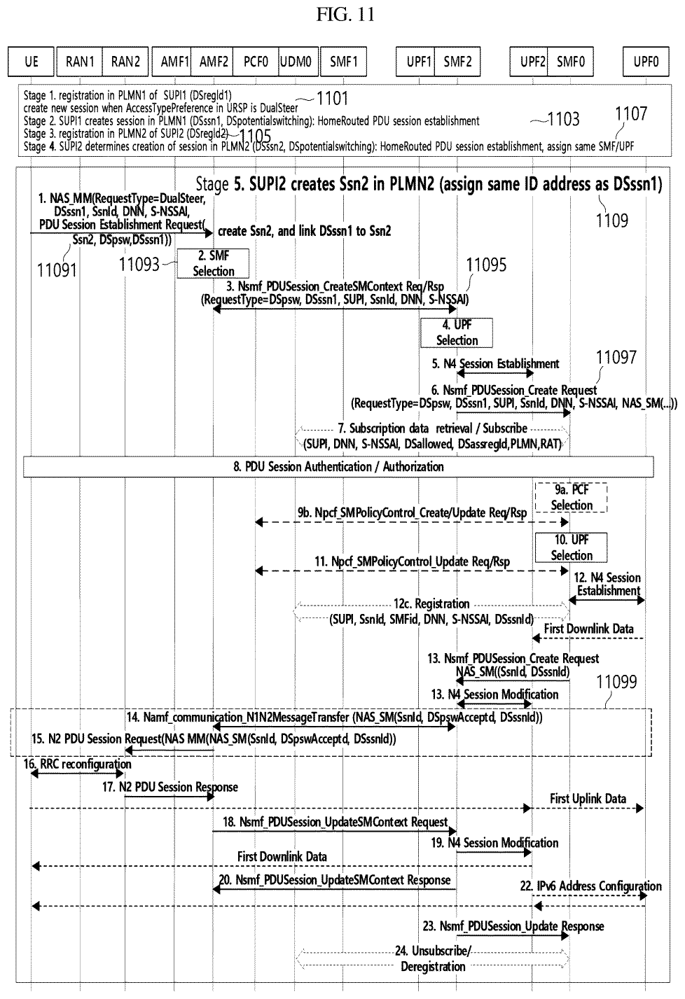

FIG. 11 shows a session establishment procedure for dualsteer traffic switching, according to an embodiment of the present disclosure.

Referring to FIG. 11, while SUPI1 is currently maintaining a DSssn1 session that was established through RAN1 to PLMN1, it is possible to use SUPI2 to establish DSssn2 to PLMN2 to prepare for potential switching of the DSssn1 session.

In the network configuration, when SUPI1 creates DSssn1 through RAN1, AMF1, SMF1, and UPF1 of PLMN1, SMF0 and UPF0 may be connected as the anchor SMF and the anchor UPF, respectively. When SUPI2 creates DSssn2 through RAN2, AMF2, SMF2, and UPF2 of PLMN2, SMF0 and UPF0, which are the anchor SMF and the anchor UPF, may be applied.

For dualsteer, each of the two access networks may be subjected to registration and session establishment used for dualsteer. Each used session may be a default session. With reference to the rule defined in the UE route selection policy (URSP), Stages 1, 2, 3, and 4 may be performed on two RATs for dualsteer. The PLMN may be determined with reference to PLMN preference. AccessTypePreference of the URSP for particular traffic may be dualsteer.

Stage 1 1101 may be the same as Stage 1 901 shown in FIG. 9A.

Stage 2 1103 may be the same as Stage 2 903 shown in FIG. 9A.

Stage 3 1105 may be the same as Stage 3 905 and 909 shown in FIG. 9A.

In Stage 4 1107, the DSD may determine creation of a dualsteer session that may be used for potential switching. The DCF of the DSD may determine creation of a dualsteer second session in order to minimize disruption of a user traffic service caused by dualsteer traffic switching that may occur in the future. The determination to create a dualsteer second session may consider at least one of the following: attenuation of a signal connected in Stage1, degradation of QOS of a session created in Stage2, and mobility of the dualsteer device. The creation of the dualsteer second session may occur automatically based on UE configuration.

In Stage 5 1109, the DSD may establish PDU Session1 in PLMN2. In FIG. 11, for ease of identification, PDU Session1 of SUPI2 is denoted by Ssn2. This session may be assigned DSssn2. DSssn2 may be assigned the same IP address as DSssn1, or may be assigned a different IP address. DSssn2 may be assigned the same PDU session ID as DSssn1, or may be assigned a different PDU session ID.

In Step 1 11091 of Stage 5 1109, the UE may include DSssnId to be potentially switched in the NAS MM message. To explicitly indicate this, the UE may change RequestType to dualsteer or dualsteer potential switching for use.

The UE may transmit PDU Session Establishment Request or PDU Session Modification Request as the NAS SM message. This request may include at least one of the following: the PDU session ID, an indication of session establishment for dualsteer potential switching, and an indication that PDU Session1 (DSssn1) of SUPI1 may be potentially switched to PDU Session1 of SUPI2, with the dualsteer identifier to be potentially switched or establishment of PDU Session1 of SUPI2.

Other settings, such as the DNN, S-NSSAI, PDU session type, and SSC mode, may be the same as those used in Stage 2 when establishing a session of DSssn1.

Step 2 11093 of Stage 5 1109 may be the same as Step 2 of Stage 5 shown in FIG. 9A.

Step 3 11095 of Stage 5 1109 may be similar to Step 3 of Stage 5 shown in FIG. 9A, but may have the following differences:
(1) DSssn1 is included as a session to be potentially switched, rather than a session to be switched
(2) RequestType also specifies potential switching

Step 6 11097 of Stage 5 1109 may be similar to Step 6 of Stage 5 shown in c 9A, but may have the following differences:
(1) DSssn1 is included as a session to be potentially switched, rather than a session to be switched
(2) RequestType also specifies potential switching

In Steps 14 and 15 11099 of Stage 5 1109, the SMF may further provide the UE with information that session creation for potential dualtsteer switching requested by the UE is accepted.

Through this procedure, the DSD may establish a session in advance in preparation for potential switching that may occur in the future. This may minimize service disruption at the point in time when actual switching is required.

The procedure in FIG. 11 has been described based on the case in which PLMN1 and PLMN2 are different, but the procedure may be reduced to apply to the case in which PLMN1 and PLMN2 are the same.

### Indirect Forwarding Method to UPF0 During Dualsteer Switching

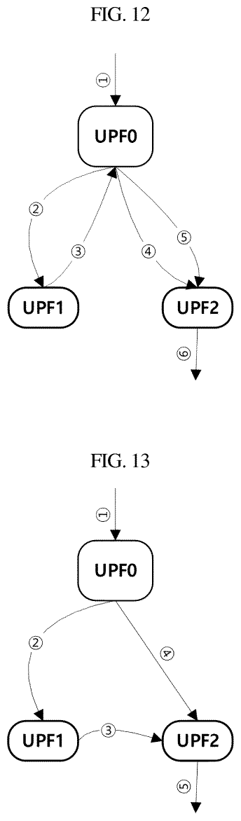

FIG. 12 shows an indirect forwarding method to UPF0 during dualsteer switching, according to an embodiment of the present disclosure. Specifically, FIG. 12 may show an indirect forwarding method to UPF0 during dualsteer switching.

Referring to FIG. 12, the traffic processing order may be as follows:
1. UPF0 may receive downlink traffic \textcircled{1} from the DN.
2. UPF0 may forward downlink traffic \textcircled{1} to UPF1.
3. When dualsteer switching occurs, UPF0 may switch traffic to UPF2.
4. UPF1 may forward (\textcircled{3}) the already received traffic \textcircled{2} to UPF0.
5. UPF0 may forward the traffic (\textcircled{4}) forwarded from UPF1 (\textcircled{3}) to UPF2 before sending downlink traffic \textcircled{1} from the DN.6. After indirect forwarding traffic from UPF1 is completely forwarded, UPF0 may send (\textcircled{5}) downlink traffic from the DN to UPF2.

UPF0 may receive, through \textcircled{3}, the Endmarker transmitted through \textcircled{2} by UPF0 to UPF1. The receiving of the endmarker may enable UPF0 to recognize that indirect forwarding from UPF1 is completed.

### Direct Forwarding Method to UPF1 During Dualsteer Switching

FIG. 13 shows a direct forwarding method to UPF0 during dualsteer switching, according to an embodiment of the present disclosure. Specifically, FIG. 13 may show a direct forwarding method to UPF1 during dualsteer switching.

Referring to FIG. 13, the traffic processing order may be as follows:
1. UPF0 may receive downlink traffic \textcircled{1} from the DN.
2. UPF0 may forward downlink traffic \textcircled{1} to UPF1.
3. When dualsteer switching occurs, UPF0 may switch traffic to UPF1 to traffic to UPF2.
4. UPF1 may directly forward (\textcircled{3}) the already received traffic \textcircled{2} to UPF2.
5. UPF2 may forward traffic forwarded from UPF1 to \textcircled{5} before downlink traffic \textcircled{4} forwarded from UPF0.
6. After direct forwarding traffic from UPF1 is completely forwarded, UPF2 may forward traffic from UPF0 to \textcircled{5}.

In addition, for switching processing:
1. UPF0 may transmit the endmarker to UPF1 through \textcircled{2} during switching.
2. UPF2 may receive the endmarker from UPF1 through \textcircled{3}.
3. The receiving of the endmarker may enable UPF2 to recognize that direct forwarding from UPF0 is completed.

### Dualsteer Switching Procedure

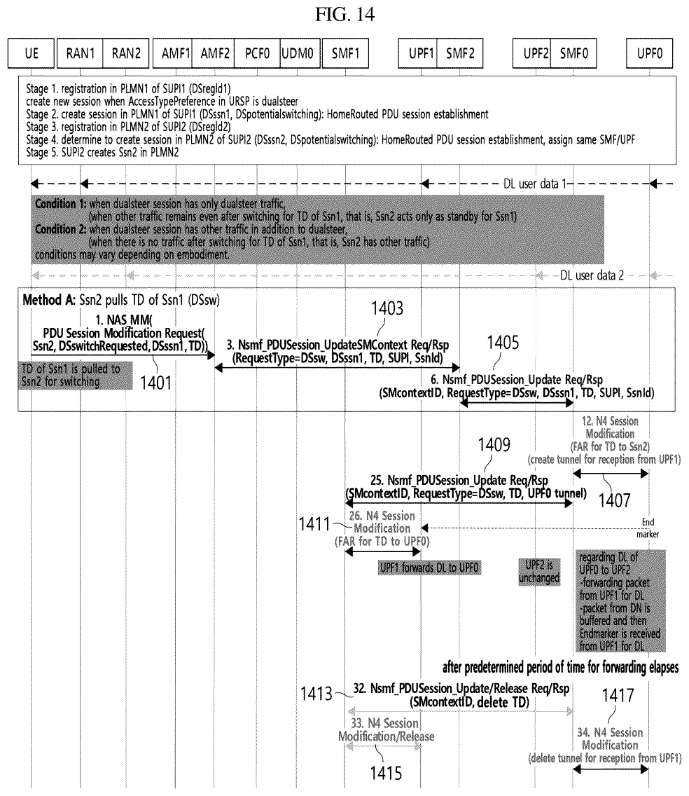

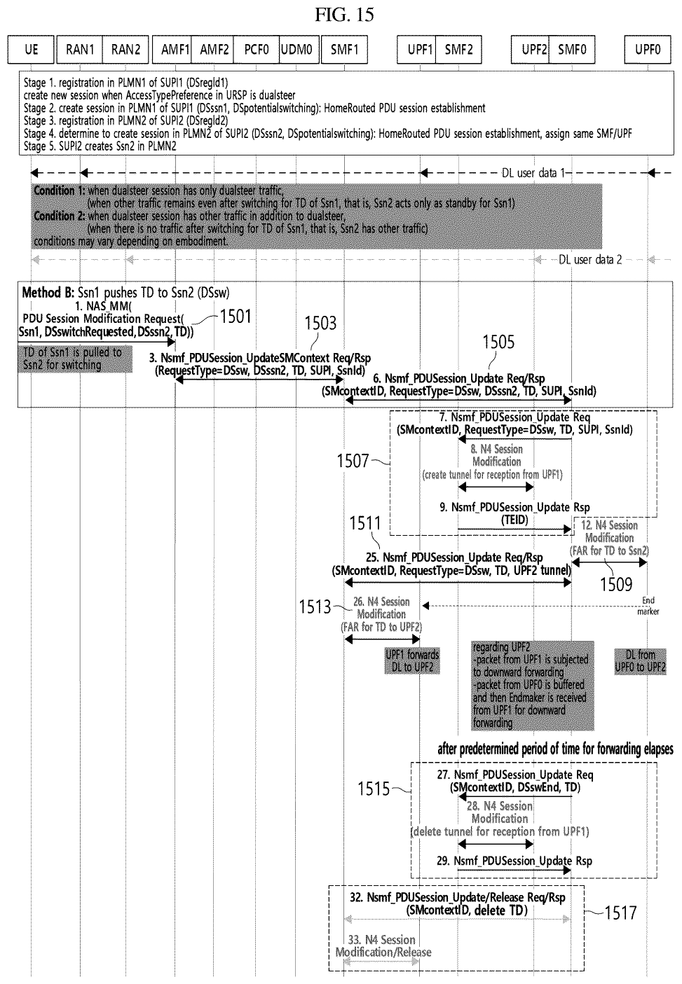

FIGS. 14 and 15 show a dualsteer traffic switching between two already setup correlated dualsteer sessions procedure, according to an embodiment of the present disclosure. Shown is a switching procedure for a second session (standby session) to be used in potential dualsteer switching created in FIG. 11.

Among traffic of Ssn1, traffic corresponding to a traffic descriptor (TD) may be switched to Ssn2 created in FIG. 11. Regarding to forwarding for the downlink during switching, indirect forwarding shown in FIG. 12 and direct forwarding shown in FIG. 13 may be selectively applied. FIG. 14 may show an example of applying indirect forwarding, and FIG. 15 may show an example of applying direct forwarding.

There are two traffic conditions for DSssn1 and DSssn2. Condition 1 is the case in which DSssn1 has only traffic for switching, and Condition 2 is the case in which DSssn1 has other traffic in addition to traffic for switching. Similarly, the case in which DSssn2 has no other traffic before switching may correspond to Condition 1, and the case in which DSssn2 has other traffic may correspond to Condition 2. In FIGS. 14 and 15, Condition 1 may be the case in which there is only DL user data 1 and no DL user data 2, and Condition 2 may be the case in which there are both DL user data 1 and DL user data 2. According to the above-described conditions, in Steps 32 and 33 in FIG. 14, after switching is completed, DSssn1 may be deleted if Condition 1 applies, or, if Condition 2 applies, the filter corresponding to the switched TD may be deleted from DSssn1.

There are two dualsteer switching methods. Method A (pull) involves pulling traffic corresponding to the target TD from the session being switched to the session receiving the switch. Method B (push) involves sending traffic corresponding to the target TD from the session being switched to the session receiving the switching.

FIG. 14 shows an example of applying Method A, and FIG. 15 shows an example of applying Method B. In FIG. 14, indirect forwarding is applied, but may be changed to direct forwarding for use. In FIG. 15, direct forwarding is applied, but may be changed to indirect forwarding for use.

Referring to FIG. 14, Method A (pull) in FIG. 14 may proceed as follows.
In step (1) 1401 of Method A, SUPI2 having Ssn2 may make a request to AMF2 for PDU session modification. This request may include at least one selected from the group of a switching request indicator, a session to be switched or information on the SUPI having the session, or a TD to be switched. DSswitchRequested (DSsw) may be used by changing the switching request indicator to indicate Method A in more detail.
In step (3) 1403 of Method A, AMF2 may forward PDU session modification request information to SMF2. AMF2 may describe the SUPI to be switched, SsnId, the TD to be switched, and DSssn1 as DSssnId to be switched. DSssn1 may use only SUPI1, or use SUPI1 and the PDU session identifier of SUPI1, or use the dualsteer session identifier.
In step (6) 1405 of Method A, SMF2 may forward session modification request information to HPLMN-SMF. This information may include information included in (3) step of Method A. This information may also include TEID for UPF2 so that UPF0 may forward to UPF2.
In step (12) 1407, SMF0 may change the dualsteer session of UPF0. When the dualsteer session of UPF0 consists of one session without distinguishing between DSssn1 and DSssn2, the FAR referenced by one MAR (Multi-Access Rule) may be changed to change the FAR set with TEID of UPF1 for the TD of the downlink traffic to the FAR set with TEID of UPF2.

When dualsteer sessions of UPF0 are operated distinguishing between DSssn1 and DSssn2, the FAR set with TEID of UPF1 with respect to the PDR of the downlink traffic TD originally set in DSssn1 may be added to DSssn2 or may be changed. For DSssn2, the PDR of the TD may be set to the FAR toward TEID of UPF2, and the PDR of DSssn2 may be set with a higher priority than the PDR of DSssn1. In addition, UPF0 may create a forwarding reception tunnel to receive a forwarding packet from UPF1, and may transmit an endmarker to UPF1. UPF0 may buffer the downlink packet from the DN and then receive the endmarker from UPF1 and perform downlink forwarding to UPF2.
In step (25) 1409, SMF0 may make a request to SMF1 that UPF1 forwards packets corresponding to the TD to the forwarding reception tunnel of UPF0.
In step (26) 1411, SMF1 may change the FAR to enable UPF1 to forward packets corresponding to the TD to the forwarding reception tunnel of UPF0.
In step (32) 1413, after a predetermined period of time required for forwarding elapses, SMF0 may command SMF1 to delete/modify (delete or modify) the session of UPF1 or delete/modify forwarding rule for TD traffic of UPF1. Alternatively, after a predetermined period of time elapses, SMF1 that has received from SMF0 a request to delete/modify the session may command UPF1 to delete/modify the session or delete/modify forwarding rule for TD traffic of UPF1.
In step (33) 1415, SMF1 may command UPF1 to delete/modify the dualsteer session or delete/modify forwarding rule for TD traffic of UPF1. Herein, steps (32) and (33) may be performed differently as deletion or modification depending on (Condition 1) and (Condition 2).
In step (34) 1417, after a predetermined period of time required for forwarding elapses, the forwarding reception tunnel created by UPF0 may be deleted.

Referring to FIG. 15, a dualsteer switching procedure of Method B (push) may be shown.
In step (1) 1501 of Method B, SUPI1 having Ssn1 may make a request to AMF1 for PDU session modification. This request may include a switching request indicator, a session to be switched or information on the SUPI having the session, and a

TD to be switched. DSswitchRequested (DSsw) may be used by changing the switching request indicator to indicate Method B in more detail.
In step (3) 1503 of Method B, the AMF may forward PDU session modification request information to the SMF1. DSsw may be the abbreviation of DSswitchRequested. AMF may describe the SUPI to be switched, SsnId, the TD to be switched, and DSssn2 as DSssnId to which switching is performed. DSssn2 may use only SUPI2, or use SUPI2 and the PDU session identifier of SUPI2, or use the dualsteer session identifier.
In step (6) 1505 of Method B, the SMF may forward session modification request information to HPLMN-SMF. This information may include information included in (3) step of Method B.
In steps (7), (8), and (9) 1507, establishment of a forwarding reception tunnel may be performed. SMF0 may make a request to SMF2 that UPF2 creates a forwarding reception tunnel from UPF1. According to the command of SMF2, UPF2 may create the forwarding reception tunnel. The TEID of the forwarding reception tunnel created by UPF2 may be forwarded by SMF2 to SMF0.
In step (12) 1509, SMF0 may change the dualsteer session of UPF0. When the dualsteer session of UPF0 consists of one session without distinguishing between DSssn1 and DSssn2, the FAR referenced by one MAR may be changed to change the FAR set with TEID of UPF1 for the downlink traffic TD to the FAR set with TEID of UPF2.

When dualsteer sessions of UPF0 are operated distinguishing between DSssn1 and DSssn2, the FAR set with TEID of UPF1 with respect to the downlink traffic TD originally set in DSssn1 may be added to DSssn2 or may be changed. For DSssn2, the TD may be set to the FAR toward TEID of UPF2, and the PDR of DSssn2 may be set with a higher priority than the PDR of DSssn1. UPF0 may transmit the endmarker to UPF1.
In step (25) 1511, SMF0 may make a request to SMF1 that UPF1 forwards packets corresponding to the TD to the forwarding reception tunnel of UPF2 (TEID in step (9)).
In step (26) 1513, SMF1 may change the FAR to enable UPF1 to forward packets corresponding to the TD to the forwarding reception tunnel of UPF2. UPF1 may transmit packets corresponding to the TD to the forwarding reception tunnel of UPF2. UPF2 may downlink forward the packet from UPF1, and may buffer the packet from UPF0 and then receive the endmarker from UPF1 and perform downlink forwarding.
In steps (27), (28), and (29) 1515, a procedure for deleting the forwarding reception tunnel may be performed. After a predetermined period of time required for forwarding elapses, SMF0 may request SMF2 to delete the forwarding reception tunnel of UPF2. SMF2 may command deletion of the forwarding reception tunnel of UPF2. SMF2 may notify SMF0 that deletion of the forwarding reception tunnel of UPF2 is completed.
In steps (32) and (33) 1517, cleanup of the session may be performed. A command may be given to SMF1 to delete/modify the session of UPF1 or delete/modify forwarding rule for TD traffic of UPF1. SMF1 may command UPF1 to delete/modify the dualsteer session or delete/modify forwarding rule for TD traffic of UPF1. Herein, steps (32) and (33) may be performed differently as deletion/modify depending on (Condition 1) and (Condition 2).

### Determination of Steering and Switching

### Dualsteer Environment

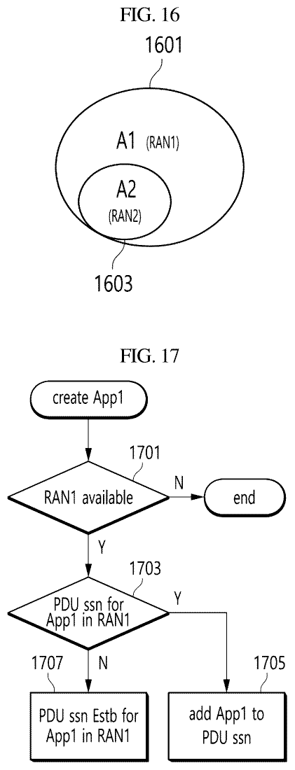

FIG. 16 shows a dualsteer environment, according to an embodiment of the present disclosure. Specifically, FIG. 16 shows an accessible area of a dualsteer environment.

Referring to FIG. 16, regarding the access areas, only RAN1 is accessible in area A1 1601, and both RAN2 and RAN1 are accessible in area A2 1603. In URSP setting, different execution conditions may be designated for respective applications. App1 may be designated to be executed only in RAN1, and App2 may be designated to be executed with dualsteer. In particular, App2 may be designated to use both RAN2 and RAN1, but RAN2 has a higher priority.

In the URSP, various attributes may be designated for each application. These attributes may include the DNN, S-NSSAI, SSC mode, PDU session type, and IP version. On the basis of the designated attributes, the application may determine the characteristics of the PDU session to use. A PDU session already exists for another application having setting the same attributes, such as the DNN, S-NSSAI, SSC mode, PDU session type, and IP version, the application wants to use, the existing PDU session may be used as it is without creating a new PDU session.

### Performance Measurement in DSD

Referring to FIG. 2, the DCF in FIG. 2 may control the measurement of performance for each RAN. The DCF is not dependent on a particular UE, and may manage performance measurement and dualsteer steering and switching of all UEs in an integrated manner. The performance management function of the DCD may be denoted as a performance management function (PMF) for convenience. This PMF may exist in both the DSD and the UPF to jointly measure performance, and the measured performance may affect dualsteer steering and switching control. The PMF of the UPF may exist in the UPF of the VPLMN or the UPF of the HPLMN or both.

The PMF of the DSD may measure performance measurable in the DSD, and may cooperate with the PMF of the UPF of the PLMN to support performance measurement between the DSD and the PLMN. The measured performance index may include at least one of the following: signal-to-noise ratio (SNR), signal-to-interference-plus-noise ratio (SINR), round-trip time (RTT), throughput (expressed in BPS), packet error rate (PER), and packet loss ratio (PLR).

The DSD may determine dualsteer steering or switching by referring to the performance index of each RAN measured by the UE(s) of the DSD or received from the PMF of the PLMN. Steering or switching to the other RAN may be determined when the performance index of a particular RAN is equal to or less than a reference value, or is equal to or less than a particular level compared to the performance index of the other RAN. Herein, the performance index may refer to instantaneous values or use statistics, such as average/minimum/maximum values over a particular period of time. In area A2, the performance of RAN1 and the performance of RAN2 are compared to select the better RAN. Herein, routing to the better RAN may be called steering when the application is not yet executed, and routing change to the better RAN may be called switching when the application is already being executed.

### Example of Determination of Steering in DSD

FIG. 17 shows an operation method for determining steering to bind a new application to an existing session in a DSD, according to an embodiment of the present disclosure. In FIG. 17, assuming that App1 is set to use RAN1 in dualsteer rule (for example in URSP), the following procedure may be performed.

When App1 is to be newly executed, it may be checked first whether RAN1 is available in step 1701. Whether RAN1 is available may be determined by whether at least one of the indices SNR, SINR, round-trip time, throughput, PER, and PLR is sufficient for the use of App1.

When RAN1 is available, it may be checked whether a PDU session available for App1 is already established in RAN1 in step 1703. Whether the existing PDU session is available may be determined by whether at least one of the DNN, S-NSSAI, SSC mode, PDU session type, and IP version that App1 wants to use is the same as the setting value of the existing PDU session.

When a PDU session satisfying this condition already exists, the session may be used as it is in step 1705.

When there is no PDU session matching a setting value required by App1, a new session may be established over RAN1 and may be used as a session for App1 in step 1707. Herein, RAN1 may include PLMN1.

FIG. 18 shows an operation method for binding a newly started application App2 to a PDU session, while the prioritized access order for App2 is set in the order of RAN2 and RAN1 as specified in dualsteer rule (for example in URSP), according to an embodiment of the present disclosure. When App2 is executed, it may be checked first whether RAN2 is available in step 1801. Whether RAN2 is available may be determined by whether at least one of the indices SNR, SINR, round-trip time, throughput, PER, and PLR is sufficient for the use of App2.

When RAN2 is available, it may be checked whether a PDU session available for App2 exists in RAN2 in step 1803.

When there is a session in which at least one of the DNN, S-NSSAI, SSC mode, PDU session type, and IP version set in App2 is the same as the setting value of the existing PDU session, the session may be used in step 1805. If not, a new session may be established in RAN2 and may be used as a session for App2 in step 1807.

When RAN2 is unavailable and RANI is available, the same procedure may be performed in RAN1 in step 1809.

When the performance index of RAN1 is sufficient, it may be checked whether a PDU session available for App2 exists in RAN1 in step 1811.

When there is a PDU session having the same setting value as App2, the session may be used in step 1813. If not, a new session may be established in RAN1 and used in step 1815.

In this process, regarding to the SUPIs used in RAN1 and RAN2, the SUPI already registered in the RAN may be used first among two SUPIs belonging to the DSD. When there is no SUPI registered in the RAN, an unused SUPI is used to perform registration first, and then a PDU session may be created in the RAN and used. In some embodiments, the SUPI to be used may be determined based on the priority of the SUPIs, which may be in dualsteer policy or pre-configured in SUPI.

### Example of Determination of Switching in DSD

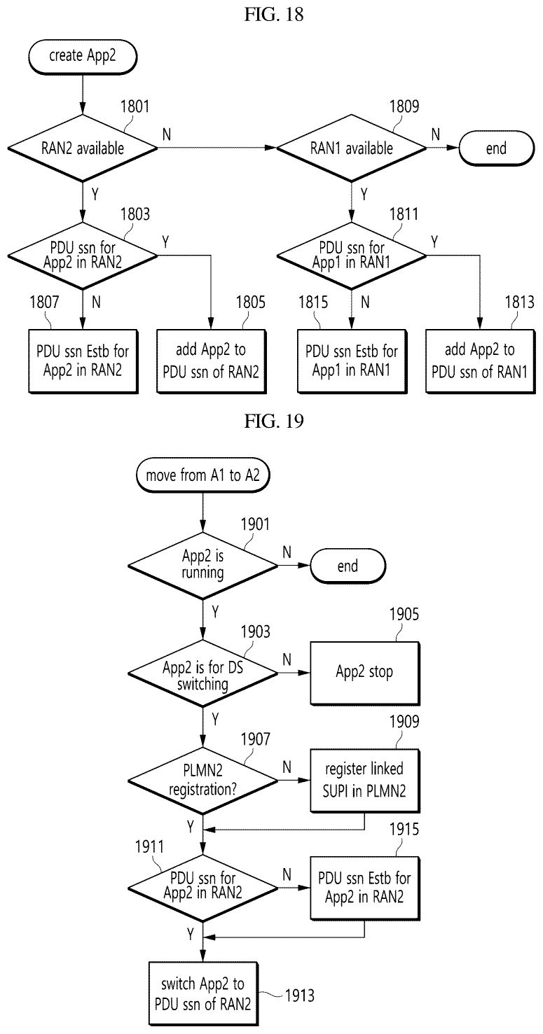

FIG. 19 shows an operation method for determining switching when a DSD moves from area A1 to area A2, according to an embodiment of the present disclosure. Shown is a process for conversion to RAN2 according to the dualsteer priority of App2 when the DSD using RAN1 for App2 in area A1 moves to area A2 and becomes able to use RAN2.

Referring to FIG. 19, when dualsteer switching is allowed and enabled in step 1903 for App2 running in step 1901, App2 may use RAN2.

However, App1 not operating in dualsteer may be out of service when RAN1 becomes unavailable.

When RAN2 belong to PLMN2, it may be checked whether registration is made in PLMN2 in step 1907. When no registration is made, an unused SUPI among the two SUPIs of the DSD is used and a registration procedure may be performed first in step 1909. In some embodiments, the SUPI to be used may be determined based on the priority of the SUPIs, which may be in dualsteer policy or pre-configured in SUPI.

Session establishment of App2 in RAN2 may be performed as follows. When a PDU session having values the same as the DNN, S-NSSAI, SSC mode, PDU session type, and IP version that App2 wants to use already exists in step 1911, the session may be used in step 1913.

When the PDU session does not exist in step 1911, a new PDU session may be created in step 1915 and App2 may be switched in step 1913. In this case, the existing session in RAN1 may be released.

Traffic processing may be performed distinguishing between uplink and downlink. In the case of uplink traffic, the DSD or UE may change a routing path of App2 from RANI session to RAN2 session. In the case of downlink traffic, the UPF may perform routing change, and the SMF may control this. To this end, a PDU session establishment or modification procedure may be used, and downlink traffic in progress may be processed through direct forwarding or indirect forwarding.

### Flow Switching Procedure Using PDU Session Establishment or PDU Session Modification

The flow switching procedure using session PDU establishment or PDU session modification may basically follow the ATSSS procedure. However, whereas ATSSS is performed as steering and switching operation or splitting between 3GPP and non-3GPP, dualsteer is performed in such a manner that RAN1 and RAN2 service different applications, App1 and App2. Therefore, improvement may be made, accordingly.

The case in which the PDU session of RAN1 services App1 and App2 and then moves App2 to the PDU session of RAN2 will be described as an example. Herein, both the PDU sessions of RAN1 and RAN2 may be dualsteer sessions.

When the DSD and the 5GC perform a session establishment or modification procedure, DSssn1 and DSssn2 may be used as identifiers for distinguishing between paths of RAN1 and RAN2. The identifier may be replaced by at least one of the following: an identifier for each access, a SUPI using an access, session correlation identifier, a leg identifier, and a session identifier. In particular, when the same session number is used, further distinguishment may be made using an access identifier, a SUPI, session correlation identifier, and a leg identifier.

When the UE of the DSD requests session establishment or modification, it may be specified that the PDU session is dualsteer, and the traffic descriptor of App2 may be designated together with a new DSssn2. In addition, DSssn1 previously used by App2 may be specified.

In response, the 5GC may perform two operations. App2 may be added to DSssn2, and App2 may be deleted from DSssn1. This operation may be performed in such a manner that the SMF adds or deletes the PDR or the FAR to or from the UPF. Alternatively, the PDR/FAR of DSssn2 is given a higher priority and is thus applied before the PDR/FAR of DSssn1, thereby obtaining the same effect without explicit deletion.

The traffic descriptor of App2 may be expressed in various ways, such as an application ID, IP descriptor, and non-IP descriptor. The IP descriptor may include information, such as an IP address, a port, and a protocol, and the non-IP descriptor may include a MAC address, and 802.10 tag information.

### Dualsteer of Active-Standby Type

A dualsteer operation method of an active-standby type may establish sessions for two accesses in advance in order to minimize service disruption caused by traffic switching of the DSD. The main features of this method may be described as follows.

When two PDU sessions for dualsteer are established in advance, efficient use of resources may be achieved from operation in the following method:
(1) Two pre-established sessions are maintained, while control for preventing waste of resources may be performed
(2) UP resources of one of the two pre-established sessions may not be assigned or may be terminated
(3) The UP resources may be assigned at the point in time when actual session switching is required
(4) When there is no application using the session after switching, the UP resources of the session may be released

Environment setting for this operation may be configured as follows:
(1) Set two SUPIs (SUPI1 and SUPI2) of the DSD
(2) Set dualsteer for a particular application in the URSP
   Set AccessTrafficPreference to dualsteer
   Use the traffic descriptor to distinguish between applications using DNN and S-NSSAI
   Set the steering mode to active-standby
   Designate RAN1 and RAN2 as primary/secondary

Session establishment and switching may be performed in the following three steps:
(1) Step 1: establish a primary session of SUPI1: make access/registration to RAN1 and create DSssn1 (primary)
(2) Step 2: establish a secondary session of SUPI2: make access/registration to RAN2 and create DSssn2 (secondary), UP resource setting may be omitted
(3) Step 3: perform switching: assign UP resources required when switching traffic of DSssn1 to that of DSssn2, and release unnecessary resources

### Registration of DSD SUPI1, and Session Establishment

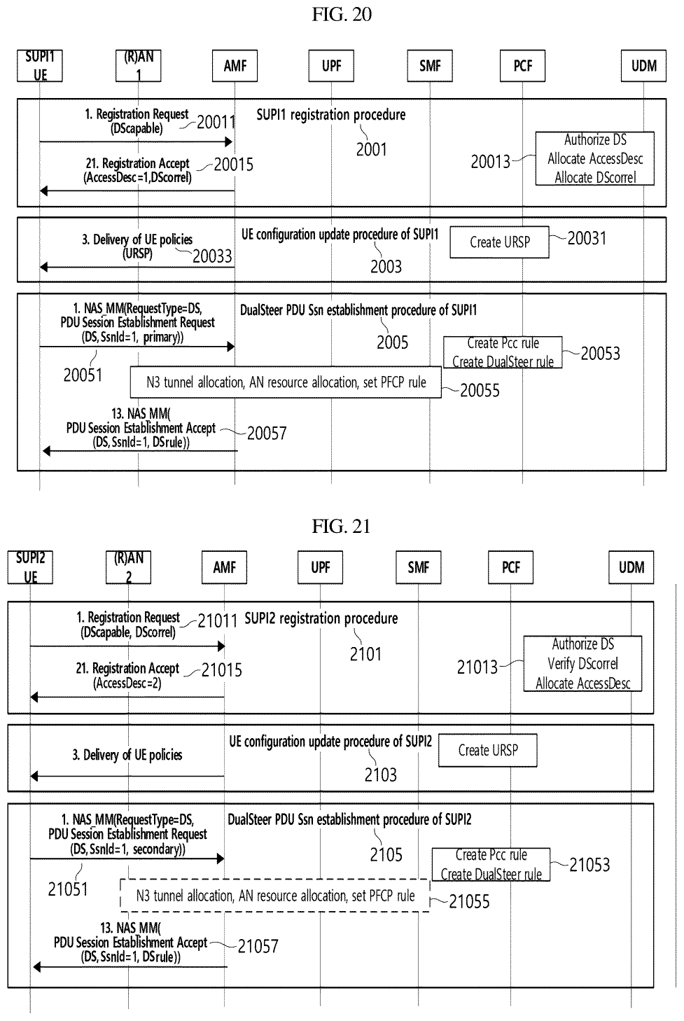

FIG. 20 shows a procedure for registering SUPI1 in RAN1 and establishing a session, according to an embodiment of the present disclosure.

Referring to FIG. 20, in step 1 20011 of a registration procedure 2001 of a first SUPI, when SUPI1 makes a request to the network for registration over RAN1, the request includes dualsteer Capable to indicate registration for dualsteer.

In the registration procedure 2001 of the first SUPI, the UDM or AMF may verify that SUPI1 is able to use dualsteer, and may assign the access descriptor to the access by the UE of SUPI1 used by the DSD in step 20013. This access descriptor may be used in the URSP or the dualsteer rule to indicate information on which RAN's path a particular application uses, and may be DSregId, for example. The UDM may also assign the DSD an identifier for indicating the correlation between two registrations to which dualsteer is to be applied, and this may be dualsteer correlation (DScorrel). DScorrel may be used when SUPI2 of the DSD is registered.

In step 21 (Registration Accept step) 20015 of the first SUPI registration procedure 2001, the AMF may provide SUPI1/UE with the access descriptor or DScorrel or both, which may have been received from the UDM.

In a UE configuration update procedure 2003 of the first SUPI, after the registration procedure, the PCF may provide the dualsteer policy, for example in URSP policy, to the UE through the UE configuration update procedure in steps 20031 and 20033.

In a dualsteer PDU session establishment procedure 2005 of the first SUPI, the DSD may transmit PDU Session Establishment Request to establish a dualsteer PDU session for using the application (App) in step 20051. Herein, the DSD SUPI1/UE may indicate the session request is dualsteer, may assign a session ID, and may indicate that the session is primary using the application. Herein, primary may be nothing more than an indication that the application is used with the session.

The PCF may perform authority verification on the dualsteer session request, and may create the PCC rule and the dualsteer rule for using the application in the session in step 20053. The PCF may provide the created rules to the SMF. The PCC rule and the dualsteer rule may be set considering the PLMN or the RAT or both in which two SUPIs of the DSD are registered. The PCC rule may be used by the SMF to set UP resources in the UPF and RAN, and the SMF may provide the dualsteer rule to the UE via the AMF. The PCC rule created by the PCF may include the dualsteer rule, and the dualsteer rule may be created on the basis of the PCC rule received by the SMF from the PCF.

In the dualsteer PDU session establishment procedure 2005 of the first SUPI, the SMF may perform AN resource assignment, N3 tunnel assignment, and PFCP rule setting to assign UP resources according to the PCC rule in step 20055. N4 Session Establishment Request, which is a PFCP session creation request for N3 tunnel resource assignment and a packet processing rule, may be transmitted to the UPF. This request may include at least one selected from the group of the PDR, FAR, MAR, and QER.

The SMF may transmit two messages through Namf_communication_N1N2MessageTransfer for AN resource assignment and N3 tunnel assignment. PDU Session resource setup request Transfer may be forwarded to the RAN, and PDU Session Establishment Accept may be forwarded to the UE through the AMF in step 20057.

Afterward, the SMF may receive, through AMF, PDU Session resource setup response transfer including N3 tunnel resource information assigned from the RAN. To this end, Nsmf_PDUSession_UpdateSMContext may be received and a response thereto may be made.

The SMF may transmit N4 Session Modification Request, which is a PFCP session modification request, to the UPF to change N3 tunnel resource information assigned from the RAN and an associated packet processing rule. This request may include at least one selected from the group of the PDR, FAR, MAR, and QER.

In the dualsteer PDU session establishment procedure 2005 of first SUPI, the SMF may transmit PDU Session Establishment Accept to the UE. This message may include an indication that the session is dualsteer and the dualsteer rule together.

### Registration of DSD SUPI2, and Session Establishment

FIG. 21 shows a procedure for registering SUPI2 of a DSD in RAN2 and establishing a session, according to an embodiment of the present disclosure.

Referring to FIG. 21, in step 1 Registration Request 21011 of a second SUPI registration procedure 2101, when SUPI2 makes a request to the network for registration over RAN2, the request includes dualsteer Capable to indicate registration for dualsteer. Registration Request may further include DSregId or DScorrel received when SUPI1 is registered.

In a processing step 21013 of the UDM during the second SUPI registration procedure 2101, the UDM may perform the following operation. The UDM or AMF may verify whether SUPI2 is able to use dualsteer. The UDM may verify that SUPI2 is associated with SUPI1 belong in to the DSD. The UDM may verify this by using the stored associated SUPI and DSregId or DScorrel or both.

In step 21 Registration Accept 21015 of the second SUPI registration procedure 2101, the AMF may provide SUPI2 or the UE with the access descriptor received from the UDM.

In a UE configuration update procedure 2103 for the second SUPI, the PCF may provide the dualsteer policy, for example in URSP policy, to the UE after the registration procedure. Herein, when the URSP to be provided is the same as the URSP provided to SUPI1, providing the URSP to SUPI2 may be omitted, and in the DSD, SUPI2 may be set to use the same URSP received from the SUPI1. The DCF of the DSD may perform coordination for the URSP of SUPI1 and SUPI2.

In a dualsteer PDU session establishment procedure 2105 of the second SUPI, the DSD may transmit PDU Session Establishment Request to establish a dualsteer PDU session for using the application (App) in step 21051. The SUPI2 or UE of the DSD may indicate that the session request is dualsteer, may assign a session ID, and may indicate that the session is secondary using the application. Secondary may be an indication that this session may be used for dualsteer traffic switching in using the application.

In the dualsteer PDU session establishment procedure 2105 of the second SUPI, the same session ID may be used for the session of SUPI1 and the session of SUPI2. For different session IDs, the same effect may be obtained by using DsCorrel, which is correlation information for two sessions, between the DSD and the SMF. Assignment of DsCorrel may be performed by either the DSD or the SMF.

In the dualsteer PDU session establishment procedure 2105 of the second SUPI, the PCF may perform authority verification on the dualsteer session request, and may create the PCC rule and the dualsteer rule for using the application in the session, and may provide the rules to the SMF in step 21053. The created PCC rule and dualsteer rule may be the same as the PCC rule and dualsteer rule provided to the SMF and the UE for SUPI1 in FIG. 20.

In the dualsteer PDU session establishment procedure 2105 of the second SUPI, the PCF may perform authority verification on the dualsteer session request, and may set the PCC rule and the dualsteer rule considering the PLMN or the RAT or both in which two SUPIs of the DSD are registered in step 21053. The PCC rule may be used by the SMF to set UP resources in the UPF and the RAN, and the SMF may provide the dualsteer rule to the UE via the AMF.

In the dualsteer PDU session establishment procedure 2105 of the second SUPI, to assign UP resources according to the PCC rule, the SMF may perform the following operation:

The SMF may provide the UPF with N4 Session Establishment Request, which is a PFCP session creation request for N3 tunnel resource assignment and a packet processing rule, wherein the request may includes at least one selected from the group of the PDR, FAR, MAR, and QER in step 21055.

The SMF may forward two messages to the AMF through Namf_communication_N1N2MessageTransfer for AN resource assignment and N3 tunnel assignment. PDU Session resource setup request Transfer may be transmitted to the RAN, and PDU Session Establishment Accept may be transmitted to the UE in step 21057.

In order to receive, from the RAN via the AMF, PDU Session resource setup response transfer including N3 tunnel resource information assigned by the RAN, the SMF may receive Nsmf_PDUSession_UpdateSMContext and make a response thereto.

The SMF may provide the UPF with N4 Session Modification Request, which is a PFCP session modification request to change N3 tunnel resource information assigned by the RAN and an associated packet processing rule, wherein the request includes at least one selected from the group of the PDR, FAR, MAR, and QER.

A procedure for AN resource assignment, N3 tunnel assignment, and PFCP rule setting for UP resource assignment may be omitted. By omitting these settings, resource waste caused by UP resource assignment of the secondary session may be reduced. In this case, AN resource assignment, N3 tunnel assignment, and PFCP rule setting may be performed in the future switching from the primary session of SUPI1 to the secondary session of SUPI2.

In the dualsteer PDU session establishment procedure of the second SUPI, selectively, AN resource assignment, N3 tunnel assignment, and PFCP rule setting may not be omitted, and may be processed as follows.

UP resource assignment according to the PCC rule may be performed, and selective deactivation for the PDU session may be performed to cancel the assigned AN resource assignment and N3 tunnel assignment, thereby obtaining the same effect. Selective deactivation of the PDU session may perform assigned AN resource release and N3 tunnel release. Even in this case, AN resource assignment, N3 tunnel assignment, and PFCP rule setting may be performed in the future switching from the primary session of SUPI1 to the secondary session of SUPI2.

Thus, through the procedure in FIG. 21, SUPI2 of the DSD may establish a secondary session in RAN2, and omission or deactivation of resource assignment may be selectively applied for efficient management of UP resources. This may enable efficient use of resources by assigning necessary resources at a later point in time when switching is required.

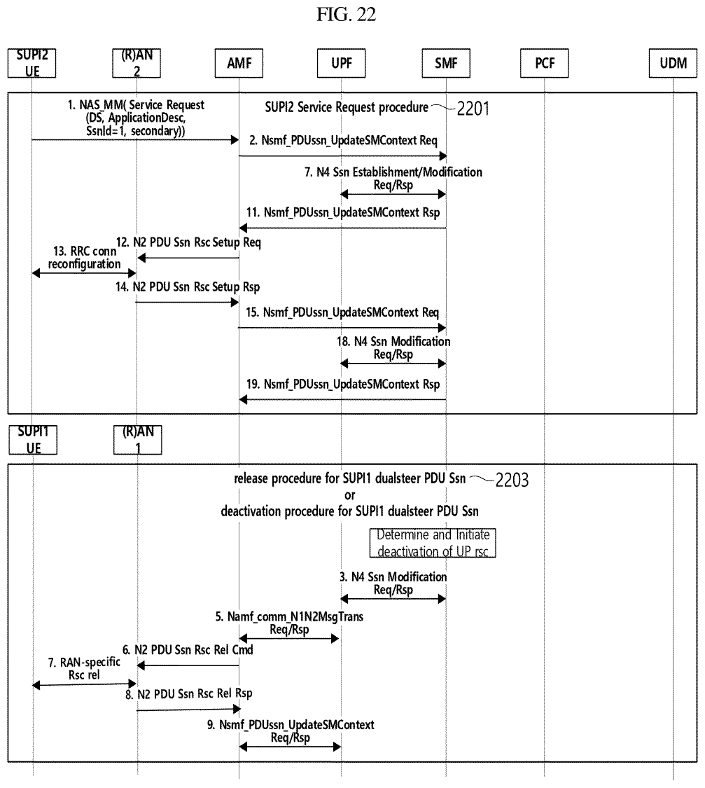

FIG. 22 shows a procedure for SUPI2 to perform switching from traffic to DSssn1 to traffic to DSssn2, according to an embodiment of the present disclosure.

Referring to FIG. 22, in step 1 Service Request of a service request procedure 2201 of a second SUPI, SUPI2 may transmit a service request over RAN2. SUPI2 may include a session identifier indicating dualsteer and recovery in this request. SUPI2 may further indicate that the PDU session is secondary. SUPI2 may further include an application description (ApplicationDesc) for a particular application to be switched. When there is no ApplicationDesc, a session may be switched from SUPI1 to SUPI2. When there is ApplicationDesc, the application may be switched from a primary session of SUPI1 to a secondary session of SUPI2.

In the service request procedure 2201 of the second SUPI, the procedures following Service Request may be performed for AN resource assignment, N3 tunnel assignment, and PFCP rule setting that are not assigned in establishment of the secondary session.

In the service request procedure 2201 of the second SUPI, the SMF may provide the UPF with at least one selected from the group of the PDR, FAR, MAR, and QER, in N4 Session Establishment Request that is a PFCP session creation request for N3 tunnel resource assignment and a packet processing rule.

For AN resource assignment and N3 tunnel assignment, the SMF may include two messages in Namf_communication_N1N2MessageTransfer and may forward the same through the AMF. The SMF may transmit PDU Session resource setup request Transfer to the RAN, and may transmit PDU Session Establishment Accept to the UE.

In order to receive, from the RAN via the AMF, PDU Session resource setup response transfer including N3 tunnel resource information assigned by the RAN, the SMF may receive Nsmf_PDUSession_UpdateSMContext and make a response thereto.

The SMF may provide the UPF with N4 Session Modification Request, which is a PFCP session modification request to change N3 tunnel resource information assigned by the RAN and an associated packet processing rule, wherein the request includes at least one selected from the group of the PDR, FAR, MAR, and QER.

In Service Request procedure 2201 of the second SUPI, when there is no application using the primary session of SUPI1 after switching from primary to secondary, the session of SUPI1 may be released or selectively deactivated in step 2203. Selective deactivation may be deactivation of data radio resources and N3 UP resources.

Switching from the primary session of SUPI1 to secondary may be performed under the following conditions:
(1) In the deactivation procedure for a dualsteer PDU session of the first SUPI, when the session is switched from primary to secondary, there may be no application using primary.
(2) After one or more applications are switched from primary to secondary, when there is no application using a primary session, the SMF may perform release of the primary session or selective deactivation of the primary session.

As a method for selective deactivation of a previous primary session of SUPI1, the SMF may perform the following operation:
(1) The SMF may provide the UPF with N4 Session Modification Request, which is a PFCP session modification request for release of N3 tunnel resource assignment and packet processing rule release for the application, wherein the request may include at least one selected from the group of PDR, FAR, MAR, and QER.
(2) The SMF may perform deactivation of AN resources and deactivation of N3 tunnel resources of the RAN.

When the primary session of SUPI1 is deactivated, primary and secondary may operate in reverse roles.

### Paging

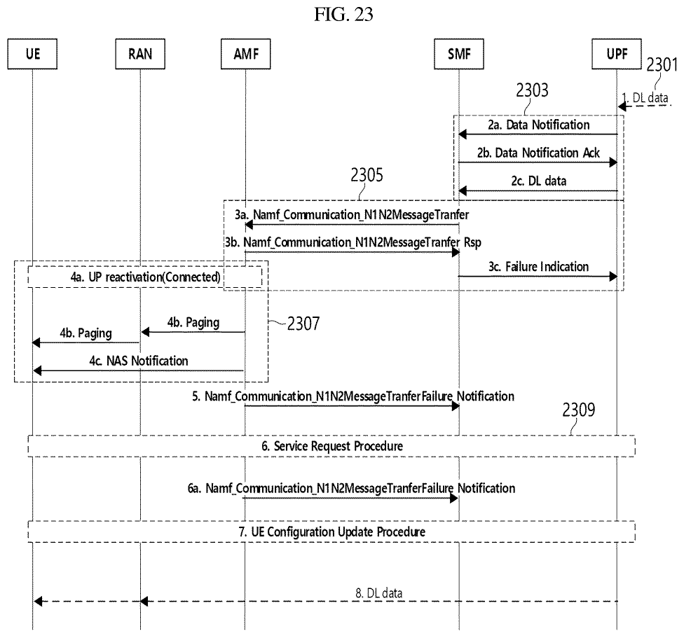

FIG. 23 shows a service request procedure, according to various embodiments of the present disclosure. Specifically, FIG. 23 shows a service request procedure in the related art described in section 4.2.3.3 of TS 23.502.

When the UE has traffic to transmit or receives a signal from the network that there is traffic for the UE to receive, the UE transmits a service request message to the network to make transition to a connected state to be assigned wireless resources and network resources and transmit and receive traffic.

Referring to FIG. 23, in step 1 of a service request procedure, the UPF may receive downlink data from the UE in step 2301.

In step 2 of the service request procedure, the SMF may receive downlink data or information on downlink data to the UE from the UPF in step 2303.

In step 3 of the service request procedure, the SMF may request the AMF to forward downlink data or information on downlink data to the UE in step 2305.

In step 4 of the service request procedure, the AMF may request the UE to forward downlink data or information on downlink data through paging in step 2307.

In step 6 of the service request procedure, in the case of PDU session-related paging in CM-IDLE state, the UE may make a UE triggered service request in step 2309. The UE may transmit and receive data according to the procedure in section 4.2.3.2 of TS 23.503.

### Paging Procedure Using Dualsteer

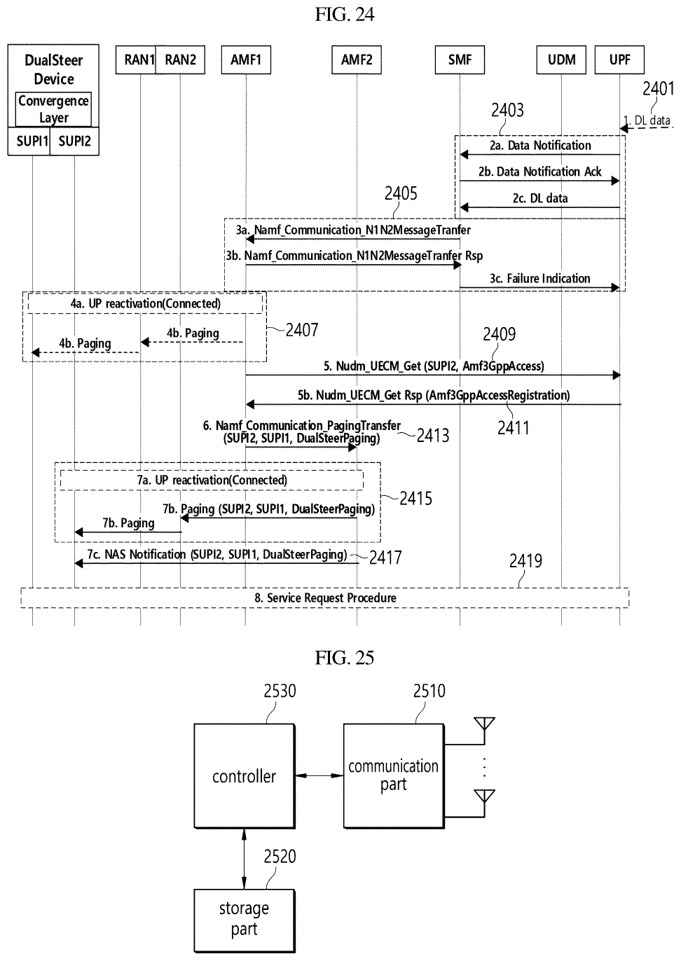

FIG. 24 shows a paging procedure using dualsteer, an embodiment of the present disclosure. according to Specifically, FIG. 24 shows a paging procedure of a dualsteer device (DSD), which is a modification of the service request in FIG. 23. This may be a procedure that enables paging through SUPI2 when the DSD has SUPI1 and SUPI2 and paging to SUPI1 is impossible. When there is incoming data for SUPI1, paging to SUPI1 is performed and incoming data is forwarded to SUPI1 in the related art. However, shown is a method of providing paging through SUPI2 when RAN1 to which SUPI1 is disconnected or a path to RAN1 has defects, when SUPI1 has defects, when SUPI1 is not registered, when paging to SUPI1 is impossible due to disconnection of SUPI1, or when SUPI1 does not respond to paging.

In step 1 2401 of the service request procedure, the UPF may receive downlink data to SUPI1.

In step 2 2403 of the service request procedure, the SMF may receive downlink data or information on downlink data from the UPF.

In step 3 2405 of the service request procedure, the SMF may request AMF1 to forward downlink data or information on downlink data.

In step 4 2407 of the service request procedure, paging forwarding attempt to the UE of AMF1 may fail or not be made.

In step 5 2409 of the service request procedure, AMF1 may be aware that the associated SUPI of SUPI1 is SUPI2 from the UDM through Nudm_SDM_Get in a registration procedure of SUPI1. AMF1 may make a request to the UDM for information on the AMF to which SUPI2 is connected when paging to SUPI1 is impossible or SUPI1 does not respond to paging. According to an embodiment, AMF1 may request AMF information for SUPI2 with Nudm_UECM_Get.

In step 5b 2411 of the service request procedure, the UDM may inform AMF1 that the AMF of which SUPI2 is in charge is AMF2. This is because the UDM has already registered AMF2 in the UDM as the AMF that manages access of SUPI2 in the registration procedure of SUPI2.

In step 6 2413 of the service request procedure, AMF1 may make a request to AMF2 for paging to SUPI2. AMF1 may use Namf_communication service. In an embodiment, AMF1 may represent paging forwarding through Namf_communication_PagingTransfer. AMF1 may alert SUPI2 to paging, and specifically may include an alert reporting paging to SUPI1.

In step 6 2413 of the service request procedure, a method may be further added to avoid an infinite loop in which step 5 2409, step 5b 24011, and step 6 2413 are performed again for SUPI1 when AMF2 is impossible or fails to perform paging to SUPI2. AMF2 may add information on the SUPI for which paging is already attempted to a list or add a paging count.

Steps 7a and 7b 2415 of the service request procedure may correspond to 4a and 4b of section 4.2.3.3 of TS 23.502. AMF2 may further include, in a paging message, that the message is a message originally to SUPI1 and the caused is forwarding due to dualsteer.

In step 7c 2417 of the service request procedure, when AMF2 transmits an NAS notification message to SUPI2, the message may further include that the message is a message originally to SUPI1 and the cause is forwarding due to dualsteer. AMF2 may indicate this as an alert reporting paging to SUPI1.

In step 8 2419 of the service request procedure, the DSD may receive the data using the service request, from either SUPI1 that is originally subjected to paging, or SUPI2 that is subjected to paging instead. The DCF of the DSD may mediate communication and control between SUPI1 (or UE1) and SUPI2 (or UE2). When registration of SUPI1 is required, the DSD may perform registration of SUPI first.

FIG. 25 shows a configuration diagram of a user equipment in a wireless communication system according to various embodiments of the present disclosure. The configuration illustrated in FIG. 25 may be understood as a configuration of a user equipment. The terms “˜part”, “˜unit”, and the like used below mean a unit for processing at least one function or operation, and may be implemented by hardware, software, or a combination of hardware and software.

Referring to FIG. 25, the user equipment may include a communication part 2510, a storage part 2520, and a controller 2530.

The communication part 2510 may perform functions for transmitting and receiving signals through a wireless channel. For example, the communication part 2510 may perform a function of conversion between a baseband signal and a bit string according to the physical layer standards of a system. For example, when transmitting data, the communication part 2510 may create complex symbols by encoding and modulating a transmission bit string. When receiving data, the communication part 2510 may restore a reception bit string by demodulating and decoding a baseband signal. In addition, the communication part 2510 may up-convert a baseband signal into an RF band signal and transmit the RF band signal through an antenna, and may down-convert an RF band signal received through an antenna into a baseband signal. For example, the communication part 2510 may include a transmission filter, a reception filter, an amplifier, a mixer, an oscillator, a DAC, and an ADC.

In addition, the communication part 2510 may include multiple transmission and reception paths. Furthermore, the communication part 2510 may include at least one antenna array composed of multiple antenna elements. In terms of hardware, the communication part 2510 may be a digital circuit and an analog circuit (for example, a radio frequency integrated circuit (RFIC)). Herein, the digital circuit and the analog circuit may be implemented as one package. In addition, the communication part 2510 may include multiple RF chains. Furthermore, the communication part 2510 may perform beamforming.

The communication part 2510 transmits and receives signals as described above. Accordingly, all or part of the communication part 2510 may be referred to as a “transmitter”, “receiver”, or “transceiver”. In addition, in the following description, transmission and reception performed through a wireless channel may be used to mean that the communication part 2510 performs the above-described processing.

The storage part 2520 may store therein data, such as default programs, application programs, and setting information for the operation of the user equipment. The storage part 2520 may be a volatile memory, a non-volatile memory, or a combination of a volatile memory and a non-volatile memory. In addition, the storage part 2520 may provide stored data according to a request of the controller 2530.

The controller 2530 may control overall operations of the user equipment. For example, the controller 2530 may transmit and receive signals through the communication part 2510. In addition, the controller 2530 may record data on the storage part 2520 and may read the data. The controller 2530 may perform functions of a protocol stack that communication standards require. To this end, the controller 2530 may include at least one processor or microprocessor, or may be part of a processor. In addition, part of the communication part 2510 and the controller 2530 may be referred to as a communication processor (CP).

According to various embodiments, the controller 2530 my perform control so that the above-described user equipment performs the operations according to the various embodiments, which will be described later.

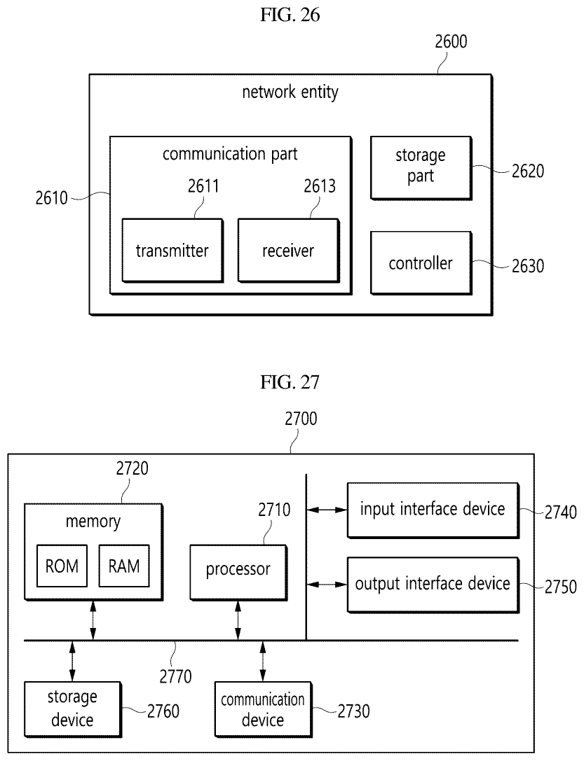

FIG. 26 shows the configuration of a network entity in a wireless communication system according to various embodiments of the present disclosure. A network entity in the present disclosure is a concept that includes a network function according to the implementation of the system. The terms “˜part”, “˜unit”, and the like used below mean a unit for processing at least one function or operation, and may be implemented by hardware, software, or a combination of hardware and software. According to various embodiments of the present disclosure, the network entity 2600 may include a communication part 2610, a storage part 2620, and a controller 2630 that controls the overall operation of the network entity 2600. The communication part 2610 transmits and receives signals to and from other network entities. Accordingly, all or part of the communication part 2610 may be referred to as a “transmitter 2611”, a “receiver 2613”, or a “transceiver 2610”. The storage part 2620 stores therein data, such as default programs, application programs, and setting information for the operation of the network entity 2600. The storage part 2620 may be a volatile memory, a non-volatile memory, or a combination of a volatile memory and a non-volatile memory. In addition, the storage part 2620 may provide stored data according to a request of the controller 2630. The controller 2630 controls overall operations of the network entity 2600. For example, the controller 2630 transmits and receives signals through the communication part 2610. In addition, the controller 2630 may record data on the storage part 2620, and may read the data. In addition, the controller 2630 may perform functions of a protocol stack that communication standards require. To this end, the controller 2630 may include a circuit, an application-specific circuit, and at least one processor or microprocessor, or may be part of a processor. In addition, part of the communication part 2610 and the controller 2630 may be referred to as a communication processor (CP). The controller 2630 may control the network entity 2600 so that any one of the operations of the various embodiments of the present disclosure is performed. The communication part 2610 and the controller 2630 are not necessarily implemented as separate modules, and may be implemented as a single component in the form of a single chip or a software block, for example. The communication part 2610, the storage part 2620, and the controller 2630 may be electrically connected to each other. In addition, the operations of the network entity 2600 may be realized by having the storage part 2620 storing the corresponding program code therein within the network entity 2600. The network entity 2600 may include a network node, and may be any one of the followings: a base station (RAN), AMF, SMF, UPF, NF, NEF, NRF, CF, NSSF, UDM, DN, AF, AUSF, SCP, UDSF, context storage, OAM, EMS, configuration server, and identifier (ID) management server.

FIG. 27 is a diagram illustrating a device configuration according to an embodiment. Referring to FIG. 27, the device may include at least one processor 2710, a memory 2720, and a communication device 2730 that is connected to a network to perform communication. In addition, the device may further include an input interface device 2740, an output interface device 2750, and a storage device 2760. Each of the elements included in the device may be connected by a bus 2770 to communicate with each other.

However, with the processor 2710 in the center, each of the elements included in the device may be connected via an individual interface or an individual bus, rather than the common bus 2770. For example, the processor 2710 may be connected via a dedicated interface to at least one of the following: the memory 2720, the communication device 2730, the input interface device 2740, the output interface device 2750, and the storage device 2760.

The processor 2710 may execute program commands stored in either the memory 2720 or the storage device 2760 or both. The processor 2710 may refer to a central processing unit (CPU), a graphics processing unit (GPU), or a dedicated processor on which methods according to embodiments of the present disclosure are performed. Each of the memory 2720 and the storage device 2760 may include either a volatile storage medium or a non-volatile storage medium or both. For example, the memory 2720 may include either read-only memory (ROM) or random-access memory (RAM) or both.

Methods according to the embodiments described in the claims of the present disclosure or in the specification may be implemented in the form of hardware, software, or a combination of hardware and software.

In the case of software implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an element included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, multiple elements expressed in the description may be configured into a single element or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. A method for establishing a session for dualsteer communication in a wireless communication system, the operation method comprising:
receiving, from a dualsteer device (DSD), a session establishment request message including support for dualsteer;
assigning a session management function (SMF) capable of supporting dualsteer;
verifying whether dualsteer is subscribed;
assigning a user plane function (UPF) capable of supporting dualsteer; and
transmitting a session establishment response message including acceptance of dualsteer to the DSD.

2. The method of claim 1, wherein the session establishment request message or the session establishment response message or both include at least one selected from a group of a dualsteer session identifier (DSssnId), a dualsteer correlation identifier (DScorrel), and a dualsteer registration identifier (DSregId).

3. The method of claim 1, wherein the support for dualsteer uses 5G session management (5GSM) capability information or a request type or both.

4. The method of claim 1, wherein when searching for the SMF capable of supporting dualsteer, the SMF capable of supporting dualsteer together with a data network name (DNN) or single network slice selection assistance information (S-NSSAI) or both is found.

5. The method of claim 1, wherein after the verifying of whether dualsteer is subscribed, when dualsteer is not supported, establishment of the session is refused or the session is accepted as an ordinary PDU session rather than dualsteer.

6. The method of claim 1, wherein the SMF is the SMF of a home network of a subscription permanent identifier (SUPI) requesting the session.

7. A method for session switching for dualsteer communication in a wireless communication system, the operation method comprising:
receiving, from a dualsteer device (DSD), a session request message including a request type indicating dualsteer switching;
assigning a dualsteer session to which switching is performed a session management function (SMF) the same as the SMF in charge of a dualsteer session to be switched;
verifying whether dualsteer is subscribed;
assigning a user plane function (UPF) the same as the UPF in charge of the dualsteer session to be switched; and
transmitting a session response message including acceptance of dualsteer to the DSD.

8. The method of claim 7, wherein the session request message includes at least one selected from a group of a dualsteer session identifier (DSssnId), a dualsteer correlation identifier (DScorrel), and a dualsteer registration identifier (DSregId) for a session to be switched.

9. The method of claim 7, wherein the session response message includes at least one selected from a group of a dualsteer session identifier (DSssnId), a dualsteer correlation identifier (DScorrel), and a dualsteer registration identifier (DSregId) for a session to which switching is performed.

10. The method of claim 7, further comprising assigning an Internet Protocol (IP) address of the dualsteer session to which switching is performed the same as the IP address of a session to be switched.

11. The method of claim 7, further comprising setting a packet detection rule (PDR) of the dualsteer session to which switching is performed to be applied before a PDR of a session to be switched.

12. The method of claim 7, wherein the DSD creates a new session by using a protocol data unit (PDU) session establishment request or a PDU session modification request or both with a non-access stratum session management (NAS SM) message.

13. The method of claim 12, wherein the NAS SM message includes at least one selected from a group of a data network single network name (DNN), slice selection assistance information (S-NSSAI), a protocol data unit (PDU) session type, and a session and service continuity (SSC) mode, and
at least one selected from the group of the data network name (DNN), the single network slice selection assistance information (S-NSSAI), the PDU session type, and the session and service continuity (SSC) mode is applied identically to a session to be switched.

14. The method of claim 7, wherein the SMF assigns a PDU session to which switching is performed a UPF the same as the UPF in charge of traffic of a session to be switched, and
the UPF is a dualsteer anchor UPF.

15. The method of claim 7, wherein the SMF provides a user equipment (UE) with information that dualsteer session switching is accepted through PDU Session Establishment Accept or PDU Session Modification Command or both.

16. The method of claim 7, wherein the SMF releases a switched session or traffic filter after switching is performed and a predetermined period of time elapses.

17. A paging method for dualsteer communication in a wireless communication system, the operation method comprising:
obtaining, when paging to a first subscription permanent identifier (SUPI) is impossible, access and mobility management function (AMF) information of a second SUPI that is an associated SUPI of the first SUPI from a unified data management (UDM),
wherein a request for paging to the second SUPI includes an indication that paging is originally to the first SUPI.
